(19) United States
(12) Patent Application Publication
(10) Pub. No.: US 2021/0251127 A1
(43) Pub. Date: Aug. 19, 2021

(54) IMPROVED TRASHER ARRANGEMENT AND PARALLELOGRAM MOUNTING SYSTEM

(71) Applicant: K FACTOR CONSULTING PTY LTD, Dalby, Queensland (AU)

(72) Inventor: Michael George PEARSON, Dalby, Queensland (AU)

(21) Appl. No.: 16/973,003

(22) PCT Filed: Jun. 7, 2019
(86) PCT No.: PCT/AU2019/050592

§ 371 Date: Dec. 7, 2020

(30) Foreign Application Priority Data
Jun. 8, 2018 (AU) 2018902081
Sep. 12, 2018 (AU) 2018903431

(51) Int. Cl. A01B 63/00; A01B 15/14; A01B 61/04

(52) U.S. Cl. CPC A01B 63/008; A01C 7/201; A01B 61/046; A01B 15/14

(57) ABSTRACT

The present invention provides a ground engaging device (10, 10.100, 10.110 and 10.120) which includes a frame assembly (12) having at least one first frame arm (14), and at least one second frame arm (16), in this case only one second frame arm (16). The at least one first frame arm (14) is located in a forward position relative to the at least one second frame arm (16) relative to the forward direction of operation of the device (10). There is also present at least one gauge wheel (18) being mounted to the at least one first frame arm (14) for rotation with respect thereto. The present invention also provides an improved parallelogram linkage, and a planter, fertiliser, cultivator or trasher with such improvements.

### FIELD OF THE INVENTION

The present invention relates to parallelogram arrangements for mounting ground engaging devices, ground engaging devices and components thereof, which can be attached to, or part of a planter; a fertiliser; a cultivator; a trasher.

### BACKGROUND OF THE INVENTION

U.S. Pat. No. 6,325,156 illustrates and describes a gauge wheel and coulter arrangement for an agricultural row unit. The gauge wheel and coulter arrangement utilises two converging gauge wheels which can translate relative to the coulter. Such an arrangement is difficult to adjust and set in the field.

Australian Patent 2009100126 illustrates and describes a gauge wheel and coulter arrangement, which is solely a trasher unit.

Any reference herein to known prior art does not, unless the contrary indication appears, constitute an admission that such prior art is commonly known by those skilled in the art to which the invention relates, at the priority date of this application.

### SUMMARY OF THE INVENTION

The present invention provides a parallelogram linkage for a ground engaging implement, the linkage having a first end for mounting to a frame for carrying and or towing one or more ground engaging implements, and a second end to which can be mounted one or more ground engaging devices or tools, the first end including spaced first bracket members to receive two first pivot pins between them, and the second end including spaced second bracket members to receive two second pivot pins between them, the linkage also including a first support arm and a second support arm which pivotally connects the first end to the second end, and wherein spacing between the first bracket members is greater than spacing between the second bracket members.

The first end and the second end can each include pivot or bolt receiving apertures, which permit either a bracket or the ground engaging device or tools, to be pinned thereto in order to lock the parallelogram linkage.

The second end can include a mounting formation for receiving a ground engaging tool, the mounting formation permitting the ground engaging tool to be rotatably secured to the second end by means of a pivot.

The mounting formation can also include means to bolt or otherwise secure the ground engaging tool.

The ground engaging device or tool, when connected to the first end and the second end thereby locking the linkage, can be retracted and when retracted is not in a ground engaging arrangement.

The ground engaging device or tool, when connected to the first end and the second end thereby locking the linkage, can be operative, at least in part, so as to be in a ground engaging arrangement.

The first and second support arm can include bushings at either end, the bushings being received between the spaced first bracket members and the spaced second bracket members.

At least one of the support arms can include a taper or converging portion in the direction of the first end to the second end.

The taper or converging portion can be present in the width and or height of the at least one support arm.

The support arm can include an upper portion and a lower portion and a first and a second side, wherein the first and second sides each include converging formations whereby the width of the support arm at a central portion of the first and second sides is different to a width of the support arm away from the central portion of the first and second sides.

The present invention provides a ground engaging device including:

a frame assembly having at least one first linkage arm and at least one second linkage arm the at least one first linkage arm being located in a forward position relative to the at least one second linkage arm relative to the forward direction of operation of the device and at least one gauge wheel being mounted to the at least one first linkage arm for rotation with respect thereto;
at least one linkage member with a first portion being coaxially mounted with respect to the axis of rotation of the at least one gauge wheel, to enable the at least one linkage member to rotate around the at least one gauge wheel axis of rotation and;
at a predetermined distance from the first portion, the at least one linkage member carries at least one implement adapted to rotate around an axis of rotation,
a second portion of the at least one linkage member being attached to the at least one second linkage arm by an attachment mechanism which is adapted to set the position of the at least one implement relative to the at least one gauge wheel.

The first and second linkage arms can be secured relative to each other.

The location of the at least one implement, can be adapted to be changed in use, relative to the at least one gauge wheel, by means of the position, and or length, of the linkage member.

The at least one gauge wheel can be a plurality of such wheels.

The plurality of wheels can have collinear or substantially collinear axes of rotation

There can be two gauge wheels. The two gauge wheels can be mounted on respective stub axles attached to said frame assembly. The stub axles can extend from said frame assembly in opposed directions, and thereby forming a space between them.

The plurality of gauge wheels can include at least two gauge wheels which are convergently arranged.

The at least one implement can be a plurality of implements. The plurality of implements can include two which are convergently arranged.

The at least one implement and the at least one gauge wheels overlap.

The diameters of the at least one gauge wheel can be less than, the same as or greater than, the diameter of the at least one implement.

The location of the at least one implement, can be adapted to be changed in use, relative to the at least one gauge wheel, by means of replacement of one linkage member with another providing different locating characteristics.

The linkage member can be of a telescoping construction.

The attachment mechanism can provide adjustment to set the relative locations the at least one implement and the at least one gauge wheel.

The axis of rotation of the at least one implement can be located between the first portion and the second portion of the at least one linkage member.

The frame assembly can include a first and second point of connection to a mounting system attached to a tool bar to be drawn by a vehicle.

The mounting system can include one or more brackets.

The mounting system can include at least one parallelogram.

When the first and the second point of connection are be connected to the mounting system, the at least one gauge wheels engage the ground.

The frame assembly can include a third point of connection, whereby when the first or the second point of connection is connected to the mounting system and the third point of connection is also connected to the mounting system, the at least one gauge wheel does not engage the ground. In this position the mounting system can be locked against movement.

The first and the second connection points can be located at one end of the frame assembly.

The third connection point can be located between the first or second connection point and the axis of rotation of the at least one gauge wheel.

The frame assembly can connect to a lower portion of the mounting system.

The frame assembly can lock the mounting system whereby the at least one implement can be adapted to be used as a cultivator for deep soil cultivation.

The mounting system can also include mounting means to attach a second ground engaging implement.

The second ground engaging device is one of: a planter tyne; a ploughing tyne, a fertilising tyne or a cultivating tyne

The at least one implement can be one of: a trasher; a coulter; a disc cultivator; a disc planter, a dual disc cultivator; a dual disc planter; a dual disc coulter.

The tool bar can be a part of one of the following: a planter; a fertiliser; a cultivator;

a trasher.

The present invention also provides a support arm for an implement mounting system, the support arm having: a first end and a second end each having at least one attachment means adapted to mount the arm in an implement mounting system; an upper portion and a lower portion and a first and a second side, wherein the first and second sides each include converging formations whereby the width of the support arm at a central portion of the first and second sides is different to a width of the support arm away from the central portion of the first and second sides.

The attachment means can enable the support arm to be pivotally attached to an implement mounting system.

The first and second sides can include one of the following: a right angle; an obtuse angle; a reflex angle.

The first and second sides can each have a cross section which is one of: cuneiform; multi-sided; or multi-faceted.

In cross section the arm can have a shape which is similar to one of the following: hexagonal, heptagonal, octagonal, nonagonal, and decagonal.

The present invention also provides an implement mounting system having at least one support arm as described above.

The mounting system can include a bias means.

The implement mounting system can include a parallelogram linkage system.

There can be at least two support arms in the implement mounting system.

At least one support arm can form an upper linkage of a parallelogram linkage system.

At least one support arm can form a lower linkage of a parallelogram linkage system.

The present invention also provides a parallelogram linkage as described above, or an implement mounting system having such a parallelogram linkage, wherein the parallelogram linkage is adapted to be locked to prevent the parallel operation of said linkage.

The linkage can include means to pivotally receive a portion of a ground engaging device at one end of the linkage, and means at another end of the linkage to receive another portion of the ground engaging device, to thereby lock the linkage from operating.

The ground engaging device can be moveable to a parallelogram linkage locked condition by means of a motive power means such as a hydraulic, pneumatic or linear actuator.

The present invention further provides parallelogram linkage for a ground engaging implement, the linkage having a first end for mounting to a bar or frame for carrying and or towing one or more ground engaging implements, and a second end to which can be mounted one or more ground engaging devices or tools, the first end including within the linkage a connection means to connect the linkage to the bar or frame.

The first end can include a shaped cut-out to receive a profile of the bar or frame.

The bar or frame can be secured to the first end by brackets.

The first end and the second end can have a compression spring mounted between upper portions thereof.

The compression spring can be located above an upper support arm of the linkage.

The present invention further provides a parallelogram linkage for a ground engaging implement, the linkage having a first end for mounting to a bar or frame for carrying and or towing one or more ground engaging implements, and a second end to which can be mounted one or more ground engaging devices or tools, the first end being adapted to receive two first pivot pins, and the second end being adapted to receive two second pivot pins between them, the linkage also including a first upper support arm and a second lower support arm which pivotally connects the first end to the second end, the linkage being characterised by a bias means being mounted between the first end and second end and above the upper support arm.

The bias means can be a compression spring.

The bias means can be adjusted to compensate for the weight of a ground engaging implement attached to the second end.

The second end can include a mounting formation for receiving a ground engaging tool, the mounting formation permitting the ground engaging tool to be rotatably secured to the second end by means of a pivot.

The first end and the second end can each include pivot or bolt receiving apertures, which permit either a bracket or the ground engaging device or tools, to be pinned thereto in order to lock the parallelogram linkage.

The ground engaging device or tool, when connected to the first end and the second end thereby locking the linkage, is retracted and is not in a ground engaging arrangement. Alternatively it can be operative, at least in part, so as to be in a ground engaging arrangement.

The present invention also provides a planter, fertiliser, cultivator or trasher having at least one of, or a combination of two or more of the following: at least one ground engaging device as described herein; at least one implement mounting system as described herein; at least one support arm as described; at least one parallelogram linkage having a support arm as described herein; at least one parallelogram linkage as described herein.

### BRIEF DESCRIPTION OF THE DRAWINGS

A detailed description of a preferred embodiment will follow, by way of example only, with reference to the accompanying figures of the drawings, in which:

FIG. 1 illustrates an rear upper isometric or perspective view of a ground engaging device embodying the invention;

FIG. 2 illustrates a right side view of the unit of FIG. 1;

FIG. 3 illustrates a left side view of the unit of FIG. 1;

FIG. 4 illustrates a plan view of the unit of FIG. 1;

FIG. 5 illustrates a front view of the ground engaging device of FIG. 1;

FIG. 6 illustrates right side view of an assembly of a ground engaging device of FIGS. 1 to 5, in a ground engaging position mounted to a parallelogram linkage mounting system which is attachable to a tool bar, the mounting system also including a rearward mounted ground engaging tyne;

FIG. 7 illustrates a front view of the assembly of FIG. 6;

FIG. 8 illustrates a rear upper isometric or perspective view of the assembly of FIG. 6;

FIG. 9 illustrates a plan view of the assembly of FIG. 6;

FIG. 10 illustrates right side view of assembly of FIG. 6, with the gauge or depth wheels not in a ground engaging position;

FIG. 11 illustrates a rear upper isometric or perspective view of the assembly of FIG. 10;

FIG. 12 illustrates a front view of the assembly of FIG. 10;

FIG. 13 illustrates a plan view of the assembly of FIG. 10;

FIG. 14 illustrates a perspective view of a support arm for a parallelogram linkage of an implement support system;

FIG. 14.1 illustrates a cross section of the support arm through a vertical plane to show the shape of the arm when welded;

FIG. 15 illustrates a right or left side view of the arm of FIG. 14;

FIG. 16 illustrates a rear to front view of the arm of FIG. 14;

FIG. 17 illustrates a plan or underneath view of the arm of FIG. 14;

FIG. 18 illustrates a rear upper perspective or isometric view of parallelogram linkage mounting system of earlier Figures, with the trasher unit replaced by an alternative trasher unit;

FIG. 19 illustrates a front view of the assembly of FIG. 18;

FIG. 20 illustrates a right side view of the assembly of FIG. 18;

FIG. 21 illustrates a plan view of the assembly of FIG. 18;

FIG. 22 illustrates a rear upper perspective or isometric view of parallelogram linkage mounting system of earlier Figures, with the trasher unit removed, and only a rearward located ground engaging tyne, with the parallelogram in a locked condition;

FIG. 23 illustrates a front view of the assembly of FIG. 22

FIG. 24 illustrates a plan view of the assembly of FIG. 22;

FIG. 25 illustrates a right side view of the assembly of FIG. 22;

FIG. 26 illustrates a rear upper perspective view of a lock linkage for assembly with the parallelogram linkage mounting system to lock that parallelogram linkage when a trasher unit is not assembled thereto;

FIG. 27 is a front view of the lock linkage of FIG. 26;

FIG. 28 illustrates a plan view of the lock linage of FIG. 26;

FIG. 29 illustrates a right side view of the lock linkage of FIG. 26;

FIG. 30 illustrates a perspective view of another support arm for a parallelogram linkage of an implement support system;

FIG. 31 illustrates a right or left side view of the arm of FIG. 30;

FIG. 32 illustrates a rear to front view of the arm of FIG. 30;

FIG. 33 illustrates a perspective view of another support arm for a parallelogram linkage;

FIG. 34 illustrates a plan view of the support arm of FIG. 33;

FIG. 35 illustrates a cross section through line A-A of FIG. 34;

FIG. 36 to FIG. 44 illustrates cross sections which can be used with the support arm;

FIG. 45 illustrates an exploded perspective view of the ground engaging device of FIG. 1;

FIG. 46 illustrates a perspective view of a ground engaging device similar to that of FIG. 1, except that two height or depth adjusters are provided;

FIG. 47 illustrates a right side view of the unit of FIG. 46;

FIG. 48 illustrates a left side view of the unit of FIG. 46;

FIG. 49 illustrates a front view of the unit of FIG. 46;

FIG. 50 illustrates a plan view of the ground engaging device of FIG. 46;

FIG. 51 illustrates a perspective view of a ground engaging device similar to that of FIG. 1, except that the gauge wheels are at an angle;

FIG. 52 illustrates a right side view of the unit of FIG. 51;

FIG. 53 illustrates a left side view of the unit of FIG. 51;

FIG. 54 illustrates a front view of the unit of FIG. 51;

FIG. 55 illustrates a plan view of the ground engaging device of FIG. 51;

FIG. 56 illustrates a perspective view of a ground engaging device similar to that of FIG. 1, except that the gauge wheels are at an angle and two coulters are also provided at an angle to each other;

FIG. 57 illustrates a right side view of the unit of FIG. 56;

FIG. 58 illustrates a left side view of the unit of FIG. 56;

FIG. 59 illustrates a front view of the unit of FIG. 56;

FIG. 60 illustrates a plan view of the ground engaging device of FIG. 56;

FIG. 61 illustrates a perspective view of the frame of an agricultural implement having a plurality of ground engaging devices;

FIG. 62 Illustrates a detailed perspective view of the circled area 62 of FIG. 61;

FIG. 63 illustrates a rear perspective view of a ground engaging device as illustrated in FIG. 1, which also has a rear located press wheel;

FIG. 64 illustrates a right side view of the unit of FIG. 63;

FIG. 65 illustrates a left side view of the unit of FIG. 63;

FIG. 66 illustrates a front view of the unit of FIG. 63;

FIG. 67 illustrates a plan view of the ground engaging device of FIG. 63;

FIG. 68 illustrates a rear perspective view of a ground engaging device, being a double disk planter;

FIG. 69 illustrates a right side view of the unit of FIG. 68;

FIG. 70 illustrates a left side view of the unit of FIG. 68;

FIG. 71 illustrates a front view of the unit of FIG. 68;

FIG. 72 illustrates a plan view of the ground engaging device of FIG. 68;

FIG. 73 illustrates a rear perspective view of a ground engaging device, being a double disc planter, which is pivoted and secured to the front and rear end of the parallelogram linkage to lock that parallelogram linkage, and retract the double disk planter;

FIG. 74 illustrates a right side view of the unit of FIG. 73;

FIG. 75 illustrates a left side view of the unit of FIG. 73;

FIG. 76 illustrates a front view of the unit of FIG. 73;

FIG. 77 illustrates a plan view of the ground engaging device of FIG. 73;

FIG. 78 illustrates an exploded perspective view of the double disc planter of FIGS. 68 to 78;

FIG. 79 illustrates the device of FIGS. 1 to 5, with a powered depth adjustment system;

FIG. 80 illustrates a side view of the device of FIG. 79;

FIG. 81 illustrates a right side view of the assembly of a ground engaging device of FIGS. 79 and 80 mounted to a parallelogram linkage mounting system which includes a powered system to move the ground engaging device to a position to lock the parallelogram linkage;

FIG. 82 illustrates a left side view of the assembly of FIG. 81;

FIG. 83 illustrates a plan view of the assembly illustrated in FIGS. 81 and 82;

FIG. 84 illustrates a schematic illustration of an open slot and cam lock or gate to receive and secure a pin of a ground engaging device to lock the parallelogram linkage;

FIG. 85 illustrates a rear perspective view of a ground engaging device, having a planter tyne and trailing press wheel, which is connected to the rear end of the parallelogram linkage while the front end is mounted to the draw bar or tool bar within the parallelogram linkage, and is illustrated in the locked condition;

FIG. 86 illustrates a right side view of the ground engaging device of FIG. 85;

FIG. 87 illustrates a rear perspective view of the ground engaging device of FIGS. 85 and 86 also having a forward trasher which can be used to lock the parallelogram linkage;

FIG. 88 illustrates a right side view of the ground engaging device of FIG. 87;

FIG. 89 illustrates an exploded perspective view of the parallelogram linkage and planter tyne;

FIG. 90 illustrates a rear perspective view of an agricultural implement frame including the ground engaging device of FIGS. 91 and 92 also utilising the parallelogram linkage of FIG. 89;

FIG. 91 illustrates a right side view of a ground engaging device of FIGS. 1 to 13 or 45 to 56 in a ground engaging condition but utilising the parallelogram linkage of FIGS. 85 to 90; and

FIG. 92 illustrates a right side view of the device and parallelogram linkage of FIG. 91 with the ground engaging device being used to lock the parallelogram linkage.

In the Figures like parts have been like numbered where the same or similar function or feature is present. In some Figures, some parts which are described in earlier figures are present, but are not identified with an item number to prevent cluttering of the Figures.

### DETAILED DESCRIPTION OF THE EMBODIMENT OR EMBODIMENTS

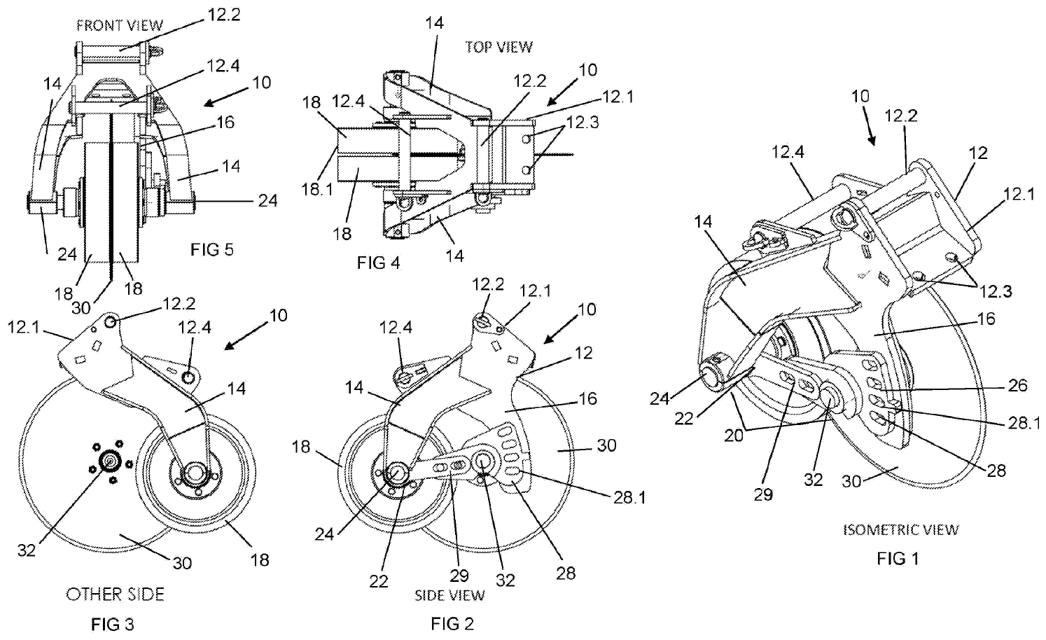

As illustrated in FIGS. 1 to 5 and 45, FIGS. 46 to 50, FIGS. 51 to 55, FIGS. 56 to 60 and in general terms, there is a ground engaging device 10, 10.100, 10.110 and 10.120 each of which includes a frame assembly 12 having at least one first frame arm 14, in this case two such frame arms 14, and at least one second frame arm 16, in this case only one second frame arm 16. The at least one first frame arm 14 is located in a forward position relative to the at least one second frame arm 16 relative to the forward direction of operation of the device 10. There is also present at least one gauge wheel 18 being mounted to the at least one first frame arm 14 for rotation with respect thereto. In this case, there is a respective gauge wheel 18 for each frame arm 14.

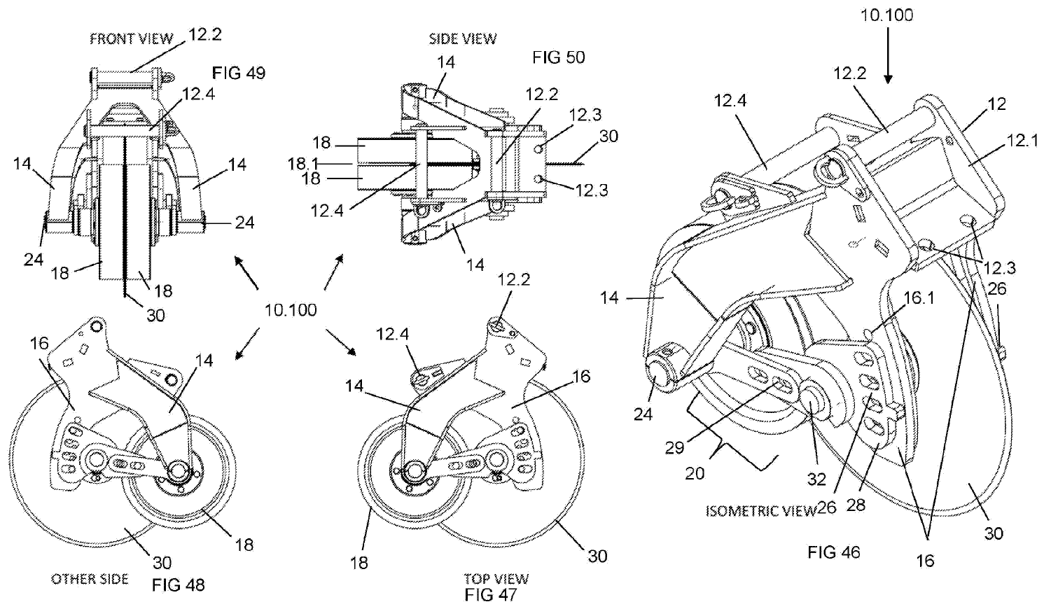

The devices 10, 10.100, 10.110 and 10.120 also include at least one adjustable linkage assembly 20 with a first portion 22 being coaxially mounted with respect to the axis of rotation or axle 24 of the at least one gauge wheel 18. The devices 10 and 10.100 of FIGS. 1 to 5, FIG. 45 and FIGS. 51 to 55 respectively show a single adjustable linkage assembly 20, while the devices 10.110 and 10.120 of FIGS. 46 to 50, and 56 to 60 respectively each have an adjustable linkage assembly 20 on either side of the device. This enables the at least one linkage assembly 20 to rotate around the at least one gauge wheel 18 axis 24 of rotation. At a predetermined distance from the first portion 22, the linkage assembly 20 carries at least one implement 30 adapted to rotate around an axis of rotation or axle 32. A second portion 26 of the at least one linkage assembly 20 being attached to the second frame arm 16 by an height or depth adjustment or attachment mechanism 28, which is adapted to set the position of the at least one implement 30 relative to the at least one gauge wheel 18.

The first frame arm 14 and second frame arm 16 are secured relative to each other, in this case by means of a welded assembly but this can be a bolted assembly, or formed from cast steel or any other appropriate method of manufacture. The frame arms 14 and 16 extend away from a mounting formation 12.1, which allows the device 10 to be bolted to existing mounting systems on agricultural or horticultural implements such as a planter; a fertiliser; a cultivator; a trasher.

The location of the at least one implement 30, is adapted to be changed according to what use the respective device 10, 10.100, 10.110 and 10.120, is to be put. This change is effected by changing the position of the implement 30 relative to the at least one gauge wheel(s) 18, by means of the position, and or length, of the linkage assembly 20. The height or depth adjustment or attachment mechanism 28, allows the position of the implement 30 to be rotated relative to the gauge wheels 18, while the elongated slots 29 enable the axle 32 to be positioned closer to, or away from the axle 24. In this way an optimum arrangement or sweet-spot to be achieved by a user, of the location and or depth of implement 30, relative to the gauge wheels 18.

As indicated above, while there can be a least one gauge wheel 18, the preferred arrangement is that there a plurality of such gauge wheels 18. This plurality of gauge wheels 18, as illustrated in FIGS. 4 and 5 for device 10, FIGS. 49 and 50 for device 10.100, have collinear or substantially collinear axes of rotation or axles 24. This is best illustrated by both of FIGS. 4 and 5 and FIGS. 49 and 50, where it can be seen that the two gauge wheels 18 are mounted on respective stub axles 24 attached to the frame assembly 12, in particular at a lower location on the arms 14. The stub axles 24 extend from the frame assembly 12 and frame arms 14 in opposed directions, and thereby form a gap or space 18.1 between them, as is best seen in FIGS. 4 and 50.

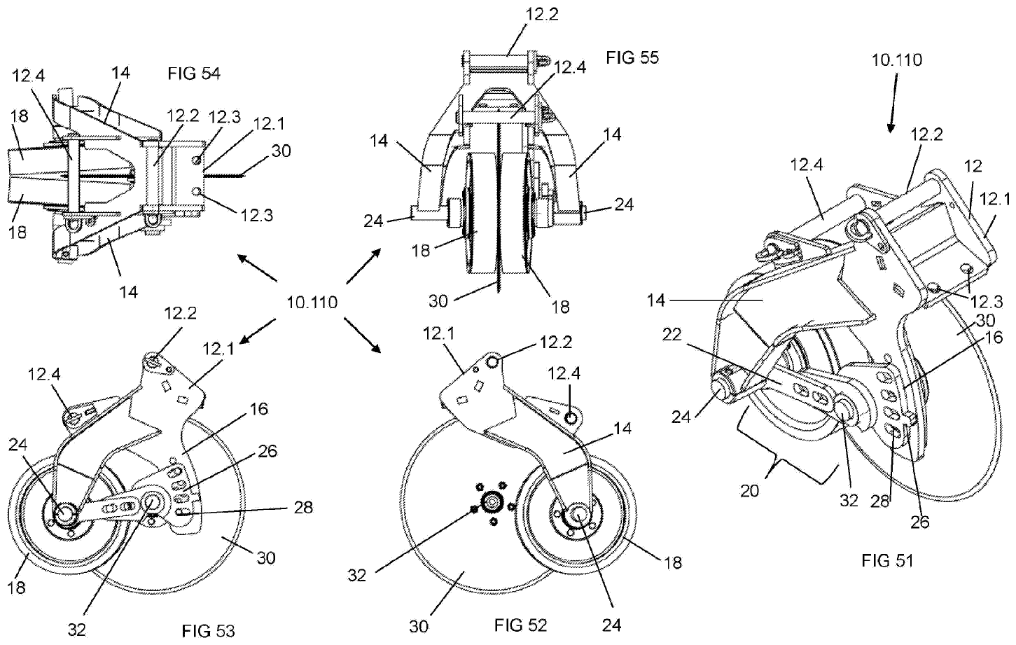

The collinear arrangement of the axles 24, means that the wheels 18 are generally parallel to each other. In the devices 10.110 and 10.120 of FIGS. 51 to 60, the plurality of gauge wheels 18 include at least two gauge wheels 18 which are arranged or constructed so as to be convergent. That is their axes of rotation provided by axles 24, are not collinear. As can be seen in FIGS. 51 to 60, left and right side gauge wheels 18 have their forward inner rims being almost in contact, while the large spacing between their peripheries is diagonally oppositely located at the rear of the gauge wheels 18, as is best viewed in the plan and front views of FIGS. 54,55,59 and 60.

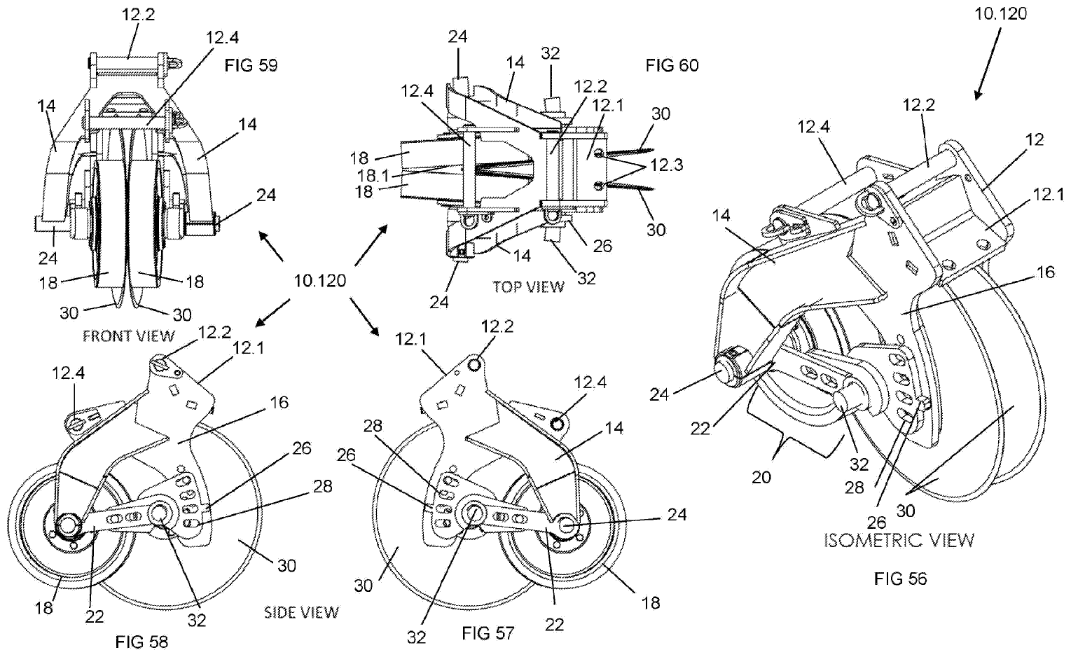

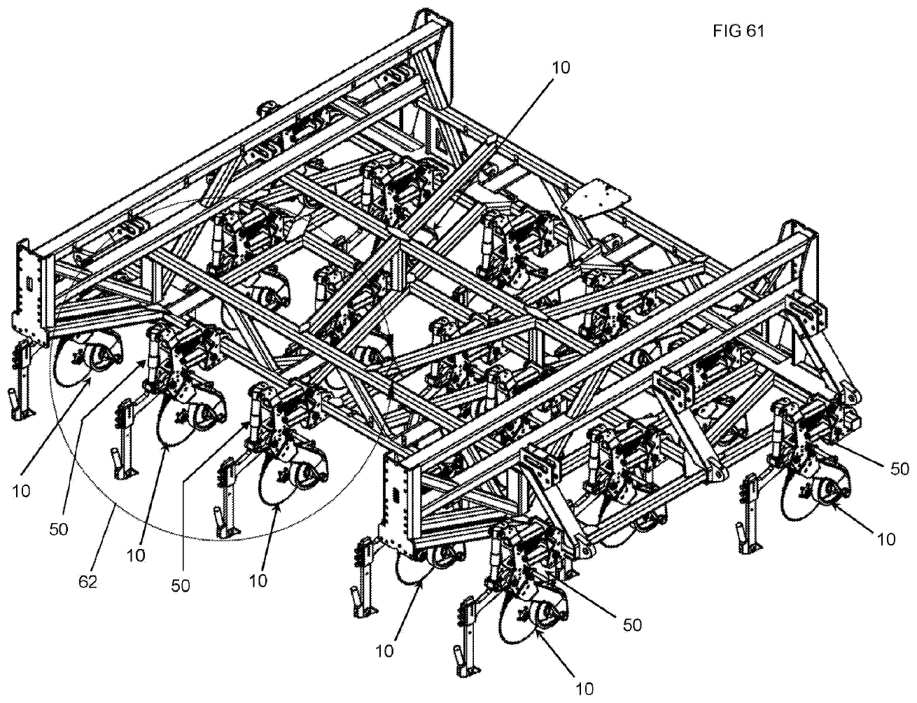

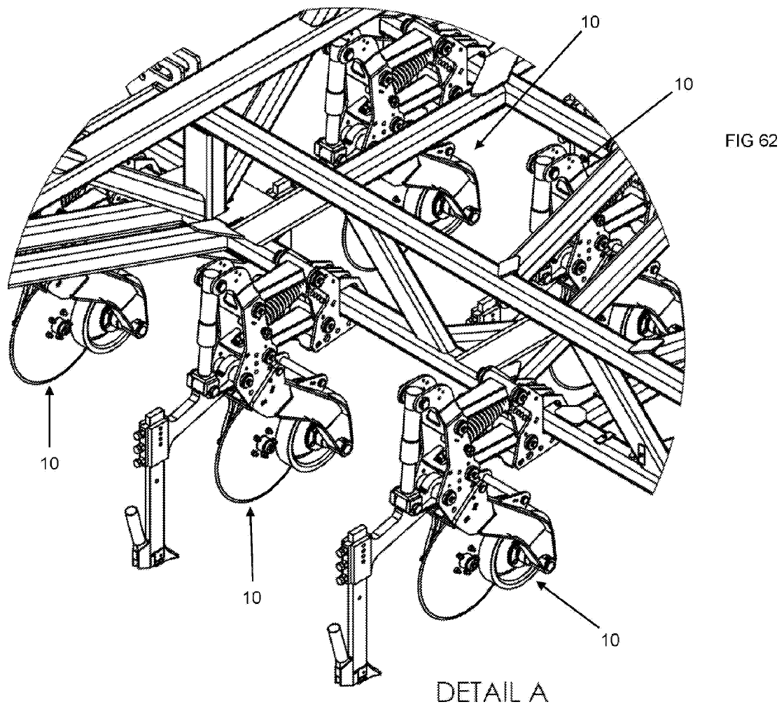

As is illustrated in FIGS. 56 to 60, the at least one implement 30 is a plurality of implements 30, in this case two coulters 30. The implements or coulters 30 are arranged or constructed so as to be convergent, in the same manner as the guide wheel 18. In the case of more than one implement 30 being utilised, the gap or space 18.1 between the adjacent gauge wheels 18 would need to be increased by changing the width of the gauge wheels 18 used or spacing the axles 24 farther apart, or providing a wider angle between the axles 24, which may require the angle of extension of the frame arms 14 laterally away from the mounting 12.1 to be increased, or smaller diameter gauge wheels to be used, thereby creating a greater gap 18.1

As is best illustrated in FIGS. 2 & 4, FIGS. 47&50, FIGS. 53&54, and FIGS. 58&60, the implement 30 and the gauge wheels 18 overlap, that is, the implement(s) 30, extend into the space or gap 18.1 between the gauge wheels 18. The diameters of the gauge wheels 18 can be chosen to be less than, the same as or greater than, the diameter of the implement(s) 30, but this is selected or decided upon by virtue of the crops, soil type, and other conditions according to a user's needs.

The linkage assembly 20 has a telescoping construction provided by the elongated slots 29. Whereas additional lateral adjustment, or distance between the axles 24 and 32 is provided by means of the locating or depth adjustment or adjustment system 28 also including four elongated apertures 28.1. The selection of one a respective of the apertures 28.1 sets the angular location of the axle 32 from the axle 24. By this means, the depth adjustment or attachment mechanism 28 provides adjustment to set the relative locations the implement 30 and the gauge wheels 18.

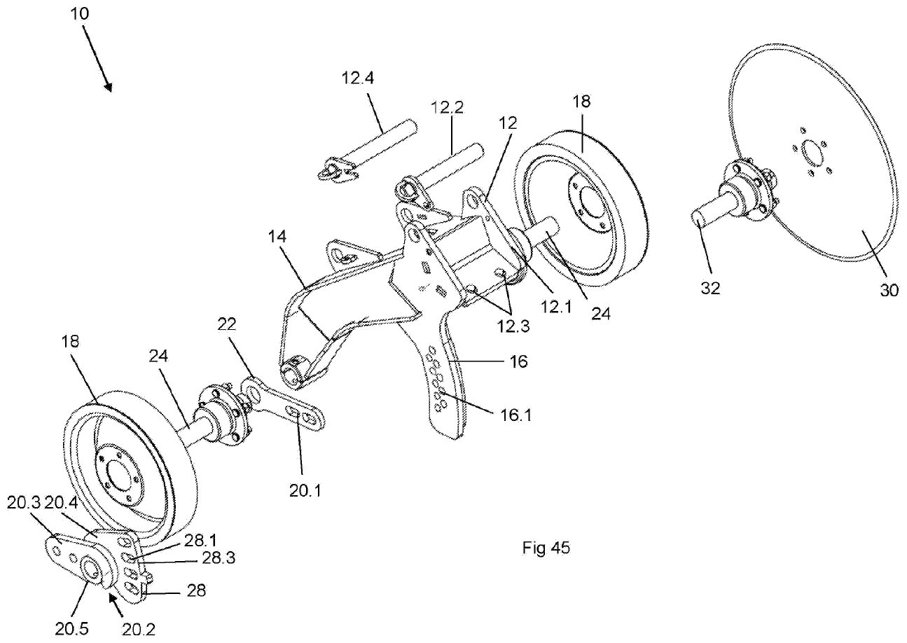

As is best seen from FIG. 45, the linkage assembly 20 has a coaxially captured bracket or first portion 22, which remains able to be rotated relative to the axle 24, but does not translate relative to the axle 24. However, by the apertures 20.1 being elongated, this allows for connector 20.3, which is welded to the rear protractor bracket 28.3, with both being welded to a cylindrical bush 20.5, which receives and secures the axle 32 of the implement 30. It can also be seen from FIG. 45, that the second frame arm 16 has an array of apertures 16.1 which allow bolts (not illustrated) to pass through a respective aperture 28.1 and through an aperture 16.1, thus providing the user with a myriad of aperture combinations to achieve the desired depth to which the implement 30 will engage the ground, and to assist, in the case of the device 10 being a trasher unit, to locate the angle of attack of the implement 30 (in such a case being a trasher blade), with respect to the gauge wheels 18, to give an optimum cutting effect of any trash located in the path of a planter tyne 60.

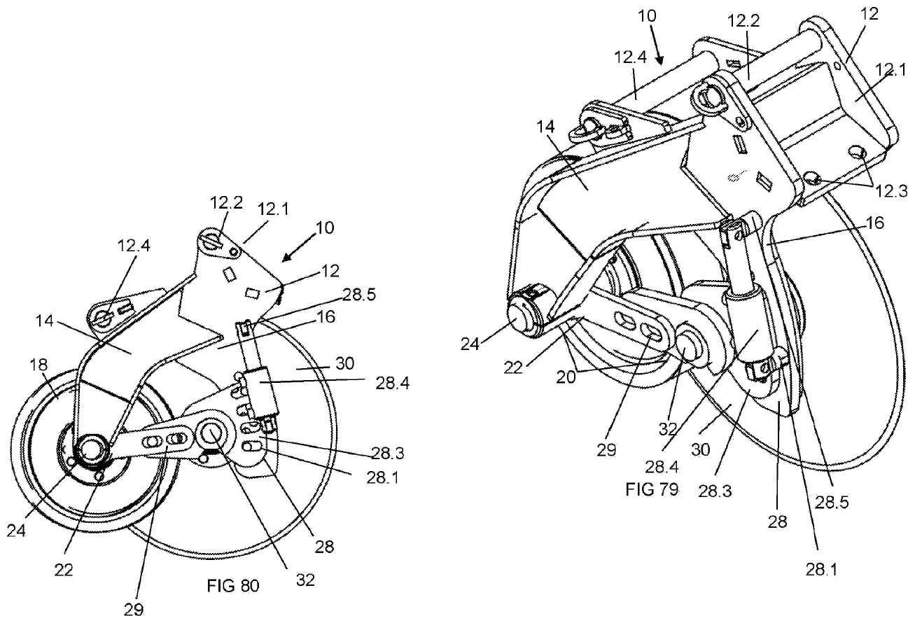

As described above, the location of the implement 30, is adapted to be set and or changed for a particular use or agricultural or horticultural application or soil tillage requirement. While the above provides for adjustment of the position of the axle 32 from axle 24, and the ability to vary the distance between them, it can also be achieved by changing position relative to the gauge wheels 18, by means of replacement of linkage members 20.2 or 22 with another of different size or length, thereby providing different locating characteristics. The linkage assembly 20, is readily achieved by means of an adjustable arrangement, which can be powered by a hydraulic cylinder, a pneumatic cylinder or linear actuator. Further, as illustrated in the two embodiments of the devices 10 of FIGS. 79 to 83 the adjustment system 28, can be aided or effected by means of a hydraulic cylinder 28.4, which interconnects the protractor bracket 28.3 and an upper location 28.5 of the frame assembly 12, so that the depth can be adjusted during use if desired, or the operator can use hydraulic assistance to get the adjustment needed, then the respective apertures or bolt holes in the adjustment system 28 can receive a locking bolt or pin to lock the adjustment system 28 into the desired position or condition. Alternatively, the hydraulic cylinder 28.4 can be substituted by a pneumatic cylinder or linear actuator.

As visible in FIGS. 1, 2 & 45, FIGS. 46&47, FIGS. 51&53, FIGS. 56&58, the axis of rotation or axle 32 of the implement 30 is secured into bushing 20.5 which is located between the first portion 22 and the second portion 26 of the linkage assembly 20. The implement 30 has its axle 32 held in the bushing 20.5 in a cantilevered fashion in the device 10, and devices 10.110 and 10.120. Whereas the provision of two frame arms 16 and adjustment linkage assemblies 20, allows the opportunity to secure a single axle 32 between opposed bushings 20.5.

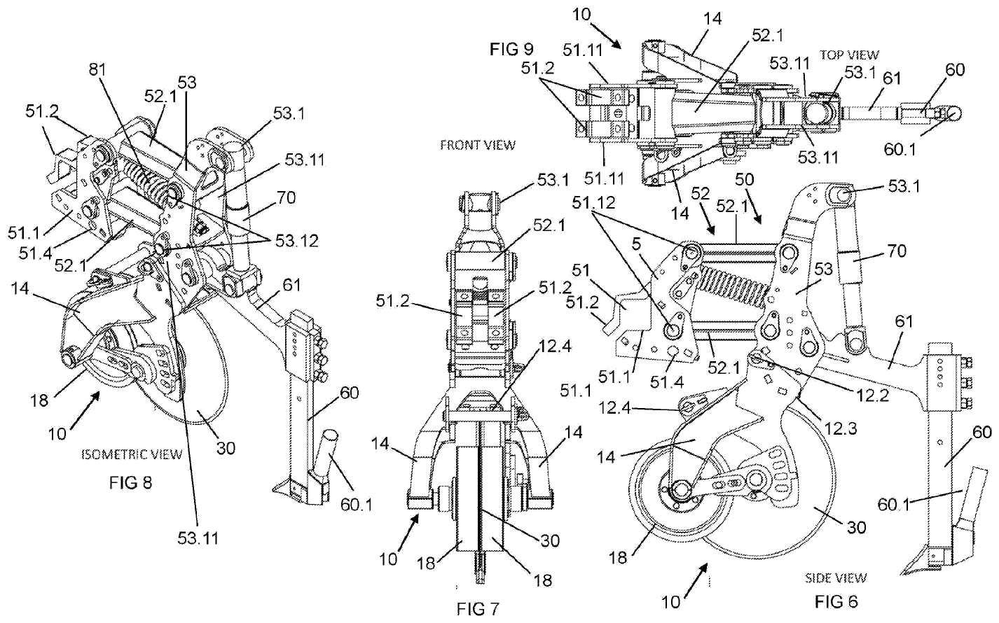

The frame assembly 12 has a first point of connection or pins 12.2 and a second point of connection or bolt holes 12.3 for receiving bolts (not illustrated), so as to attach to a mounting system 50 as illustrated in FIGS. 6 to 9.

FIGS. 6 to 9 and 63, illustrate what can be described in general terms as a parallelogram linkage 52, which is for a ground engaging implement or implement mounting system. The linkage 52 has a first end 51.1 for mounting to a frame 51 for carrying and or towing one or more ground engaging implements such as devices 10, 10.100, 10.110 or 10.120. The linkage 52 has a second end 53 to which can be mounted one or more ground engaging devices or tools 10, 10.100, 10.110 or 10.120, and tyne 60. The first end 51.1 includes spaced first bracket members 51.11 which have apertures to receive two first pivot pins 51.12 between them. The second end 53 includes spaced second bracket members 53.11 which have aligned and oppositely located apertures to receive two second pivot pins 53.12 between them. The linkage 52 also includes a first support arm 52.1 and a second support arm 52.1 which pivotally connects the first end 51.1 to the second end 53, and wherein spacing between the first bracket members 51.11 is greater than spacing between the second bracket members 53.11.

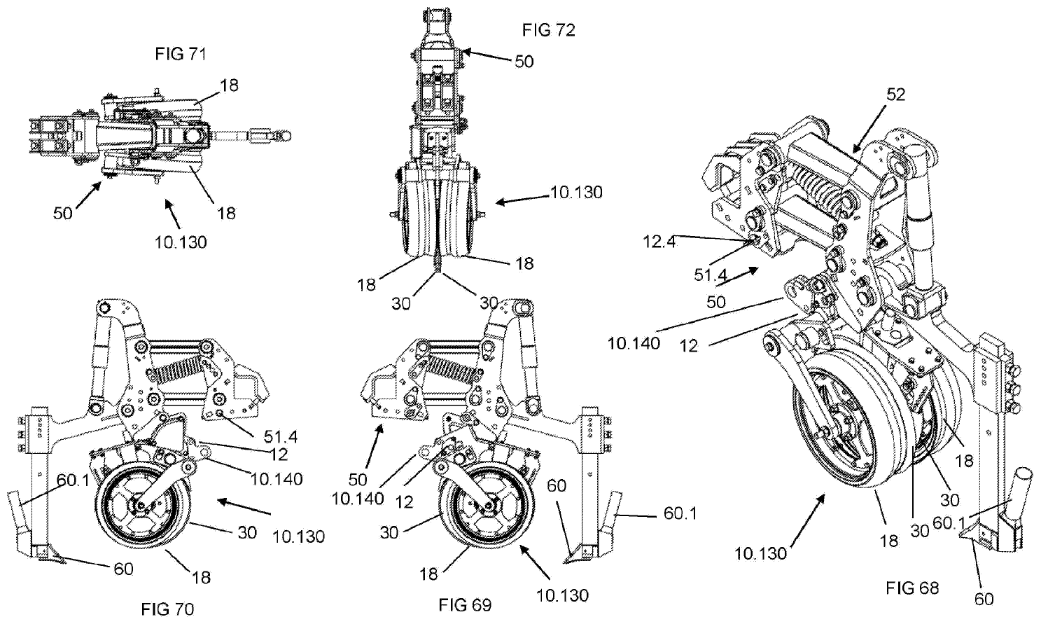

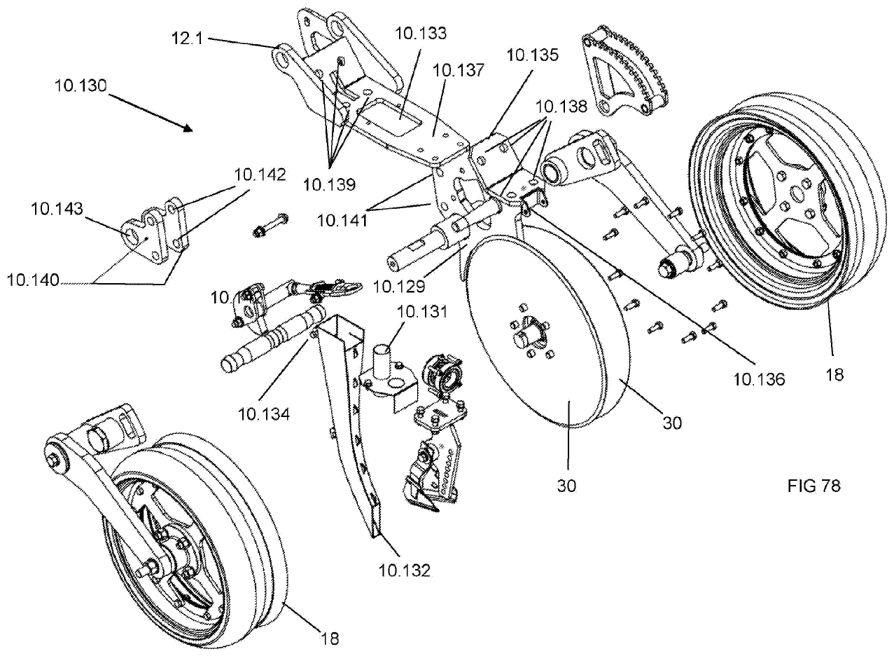

The first end 51.1 and the second end 53 can each include pivot or bolt receiving apertures, which permit either a bracket 90 or the ground engaging device or tools 10, 10.100, 10.110, 10.120, 10.130 (see FIGS. 68 to 78), to be pinned thereto in order to lock the parallelogram linkage 52, to thereby prevent it from having its components move relative to each other. This desirable in some tillage and soil operations.

The second end 53 includes a mounting formation 53.13 for receiving a ground engaging tool mounting formation 12.1, with the mounting formation 53.13 permitting the ground engaging tool 10, 10.100, 10.110, 10.120, 10.130 to be pivotally secured to the second end 53 by means of a pivot or pin 12.2.

The mounting formation 53.13 also includes bolt holes to bolt or otherwise secure the ground engaging tool 10, 10.100, 10.110, 10.120, 10.130 to the mounting formation 53.13.

The ground engaging device or tool 10, 10.100, 10.110, 10.120, 10.130, when connected to the first end 51.1 and the second end 53, thereby locking the linkage 52, can allow the implement 30 to be retracted so that when retracted it is not in a ground engaging condition. In this condition the gauge wheels 18 are also not in a ground engaging condition. Further, when in this condition, that is connected to the first end 51.1 and the second end 53 thereby locking the linkage 50, the gauge wheels 18 can be maintain in their ground non-engaging condition, and by means of the adjustment system 28 continuing to be operative, at least in part, the implement 30 can be moved to a ground engaging condition.

The first and second support arms 52.1 include bushings 52.5 and 52.6 at either end, with the bushing 52.5 being received between the spaced first bracket members 51.11 and the bushing 52.6 being received between the spaced second bracket members 53.11. At least one of the support arms 52.1, or each of them, can include a taper or converging portion in the direction of the first end 51.1 to the second end 53. The taper or converging portion can be present in the width and or height of the at least one support arm 52.1.

The support arms 52.1 include an upper side 52.7 and a lower side 52.8 and a first 52.10 and a second side 52.11, wherein the first side 52.10 and second side 52.11 each include converging formations whereby the width of the support arm at a central portion of the wherein the first side 52.10 and second side 52.11 is different to a width of the support arm away from the central portion of the wherein the first side 52.10 and second side 52.11.

The mounting system 50 can be or is attached, by means of first end brackets 51.1 and securing brackets 51.2 and bolts (not illustrated) to a tool bar 51 to be drawn by a vehicle (not illustrated).

The brackets 51.1 and 53 of the mounting system 50 are constructed from spaced first bracket members 51.11 and spaced second bracket members 53.11 which are manufactured from 10 mm thick steel plates of grade 1045 steel. These brackets 51.1 and 53 form respectively the forward and rearward linkages of the parallelogram linkage system 52. The parallelogram linkage system 52 is completed by the upper and lower support arms 52.1, which are described in more detail herein.

As is illustrated in FIG. 6, when the first point of connection or pin 12.2 and the second point of connection being bolt holes 12.3 are connected to the mounting system 50, the gauge wheels 18 will engage the ground.

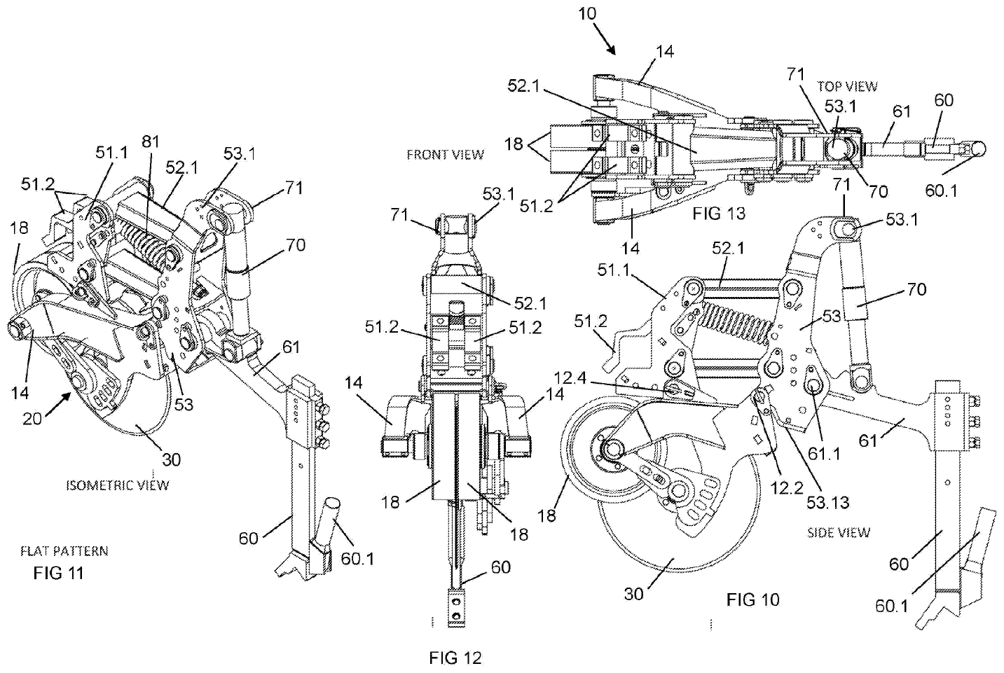

The frame assembly 12 includes a third point of connection 12.4, whereby when the first or the second point of connection 12.2 and 12.3, in this case the second point of connection 12.2 is connected to the mounting system 50 and the third point of connection 12.4 is also connected to the mounting system 50, by means of pin 12.4 being positioned in holes 51.4 on the bracket 51.1, the gauge wheels 18 do not engage the ground, as illustrated in FIGS. 10 to 13. In this position or arrangement the mounting system 50 is locked against movement that the parallelogram linkage system would otherwise provide. This is achieved because the line between the points of connection or pins 12.4 and 12.2 do not form parallel line to the two support arms 52.1. Apertures in brackets 51.1 and 53 receive the pins 12.2 and 12.4, which are locked into place relative to the brackets 51.1 and 53, on one side of brackets 51.1 and 53, by means of conventional pin securing mechanisms which utilise lynch pins, as is illustrated.

The first and the second connection points or pins 12.2 and 12.3 are located at one end of the frame assembly 12 close to the mounting formation 12.1. Whereas the third connection point 12.4 is located between the first or second connection points 12.2 and 12.3 and the axis of rotation or axle 24 of the gauge wheels 18.

As is illustrated in FIGS. 10 to 13, the frame assembly 12 can connect to a lower portion of the mounting system 50, to thereby lock the parallelogram linkage in the mounting system 50, by the pin 12.4 passing through the holes 51.4 in bracket 51.1 and through the frame assembly 12. The locking of the mounting system 50 allows the implement 30 to be used as a cultivator for deep soil cultivation. Additionally the rearward located ground engaging tyne 60 can also provide by itself or in combination with the implement 30, deep cultivation. The tyne 60 is mounted on a rearwardly extending bracket 61 which is pinned by pin 61.1 to bracket 53, at a lower location, and is connected by a hydraulic cylinder 70 to an upper location 53.1. This allows a vehicle operator to adjust the depth at which the tyne 60 will engage the ground. The Tyne 60, if part of a planter can excavate a channel into which seed can be placed, or can be used for deep tillage or ploughing or can be fertilising or cultivating tyne. Thus the mounting system 50 includes mounting means 61 and 71 to attach a second ground engaging implement 60. When the frame assembly 12 is stowed into locked position of FIGS. 10 to 13, the coulter 30 can also be adjusted to its lowest position on the depth adjusting means 28 to allow the coulter to work without the gauge wheels 18. The coulter 30 can then be used to cut trash and provide shallow cultivation while allowing tyne 60 to complete cultivation without racking trash.

The implement 30 be one of: a trasher; a coulter; a disc cultivator; a disc planter, a dual disc cultivator; a dual disc planter; a dual disc coulter. While only a coulter is illustrated in the Figures, it will be understood that other implement types can be present.

The tool bar 51 can be a part of: a planter; a fertiliser; a cultivator; or a trasher.

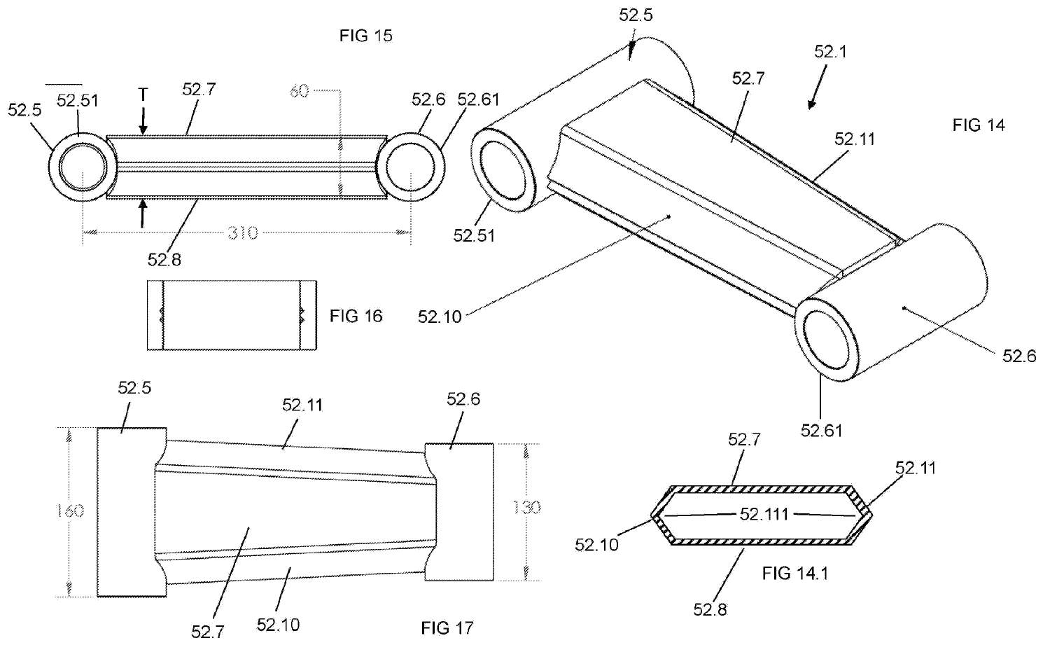

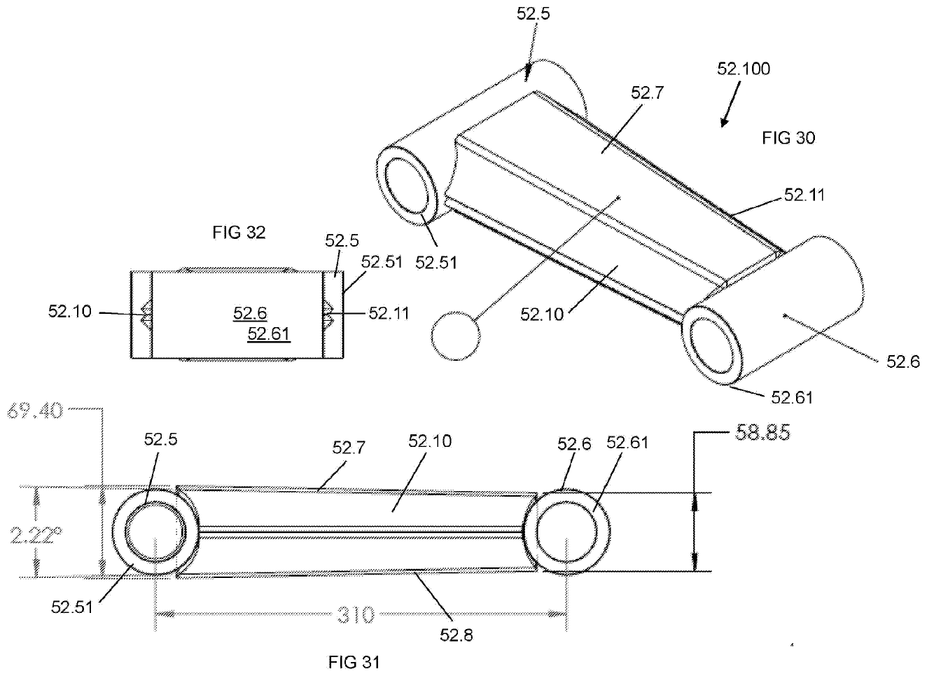

As illustrated in FIGS. 14 to 17, 30 to 32 and 33 to 35, and in general terms, there are support arms 52.1, 52.100 and 52.1000 illustrated for an implement mounting system 50. The support arms 52.1, 52.100 and 52.1000 have a first end 52.5 and a second end 52.6, each having at least one boss or mounting means 52.51 and 52.61 at each end, which are adapted to mount the respective arms 52.1, 52.100 and 52.1000 into the implement mounting system 50 or parallelogram linkage thereof. The arms 52.1, 52.100 and 52.1000 have an upper side 52.7 and a lower side 52.8 and a first side 52.10 and a second side 52.11. The upper side 52.7 and the lower side 52.8 are converging from the first end 52.5 to the second end 52.6, in the case of all three arms 52.1, 52.100 and 52.100, in plan view as in of FIG. 17 for arm 52.1, FIG. 17 for arm 52.100 as it has the same plan view, and FIG. 34 for arm 52.1000. Alternatively, the first side 52.10 and the second side 52.11 are converging from the first end 52.5 to the second end 52.6 in side view as illustrated in the side view of FIG. 31 of arm 52.100. The converging can also be in both the side views and plan views as is the case in the arm 52.100.

The first side 52.10 and second side 52.11 are each shaped so as to contain an included angle 52.111, which results in a cuneiform shape or chevron shape, as can be seen from FIG. 14.1, which illustrates the cross section of both of arms 52.1 and 52.100.

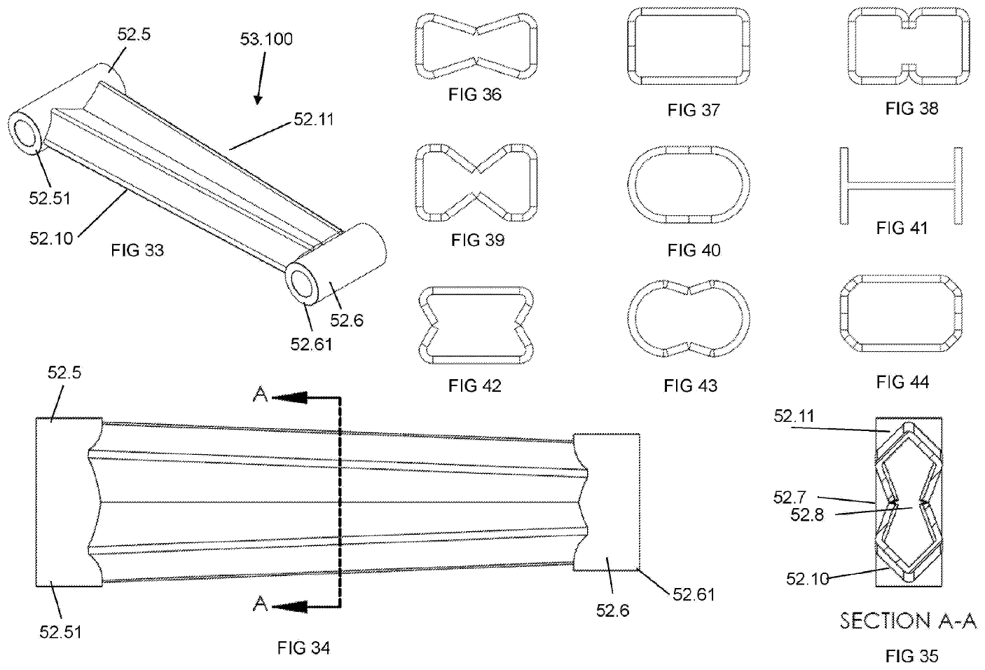

The upper and lower halves of the support arms 52.1 and 52.100 are preferably identical in shape, and when held together, provide an externally located V-shape channel or groove to allow the upper and lower halves to be fillet welded together along a line in their horizontal plane of joining.

Whereas the support arm 52.1000 of FIGS. 33 and 34, as is illustrated in the cross section of FIG. 35, is made from left and right sides which are also identical in shape, and when held together provide an internally located V-shape channel or groove to allow the left and right halves to be fillet welded together along their vertical plane of joining. It will be noted that the cross section of FIG. 35 shows that the arm 52.100 results in a V-shaped channel in the upper side, while an inverted V-shape channel is formed in the lower side, with eth left and right sides being cuneiform or chevron shaped.

In FIGS. 35 to 44 are representations of the fabricated cross sections that the left and right side halves may have, or the upper and lower halves may have to construct the central portion of the a support arms 52.1, 52.100 and 52.1000.

The cylindrical bushes or mounting means 52.51 and 52.61, which are formed from cylindrical tubes, which can include bearings if needed, to allow the support arm 52.1 to be pivotally attached in the implement mounting system 50, so as to form a parallelogram linkage arrangement. The cylindrical bushes 52.51 and 52.61 are welded along the whole length of contact with the upper side 52.7, the lower side 52.8, first side 52.10 and second side 52.11. These sides can be of a welded construction which can be either made from a stainless steel or a mild steel to suit the parallelogram linkage design requirements.

The first side 52.10 and second side 52.11 can include between them, and the upper side 52.7 and lower side 52.8 can include between them, one of the following: a right angle; an obtuse angle; a reflex angle, as is illustrated in FIGS. 14.1 and FIGS. 35, 36, 39 43. Additionally, they can each have a cross section which is one of: cuneiform; multi-sided; or multi-faceted.

In cross section the support arm 52.1 can have a shape, when assembled and welded which is as illustrated in FIGS. 14.1 which can be broadly described as hexagonal However other shapes such as octagonal as in FIG. 44 can be used, and others like heptagonal, octagonal, nonagonal, decagonal. The cross section of support arm 52.100 is the same as that of support arm 52.1, whereas the cross section of support art 52.1000 is as illustrated in FIG. 25. The cross sectional or shaped construction described above give the support arms 52.1, 52.100 and 52.1000 improved functioning in resisting the forces applied to the support arms 52.1, 52.100 and 52.1000 during use.

The arms 52.1 can be made from two halves (or more pieces) of 6 mm grade 350 steel folded to the appropriate shape and welded together to form the central arm portion, and then this is welded to two 65 mm diameter 1045 grade steel round bar to form the bushes 52.5 and 52.6, which are first turned to hollow them out to accept 38 mm or 1.5 inch nylon bushes or similar bearing material.

The implement mounting system 50 has at least one support arm 52.1 as described above. In the system 50 illustrated there are two such support arms 52.1. It will also be noted from FIGS. 14 to 17, that the support arm 52.1 has a relatively constant thickness or depth T as illustrate in FIG. 15, but in the plan or underneath view of FIG. 17, the support arm 52.1 tapers from its front end 52.5 to its rear end 52.6. This is due to the bracket 51.1, which is formed from two like bracket side and a space between them, has a different spacing to the bracket 53, which is also formed from two like bracket sides and a space between them as is best illustrated in the plan views of FIGS. 9, 13, 21 and 24. If the respective size of the spaces provided in the brackets 51.1 and 53 were the same, then the arms 52.1 would not need to taper in plan view.

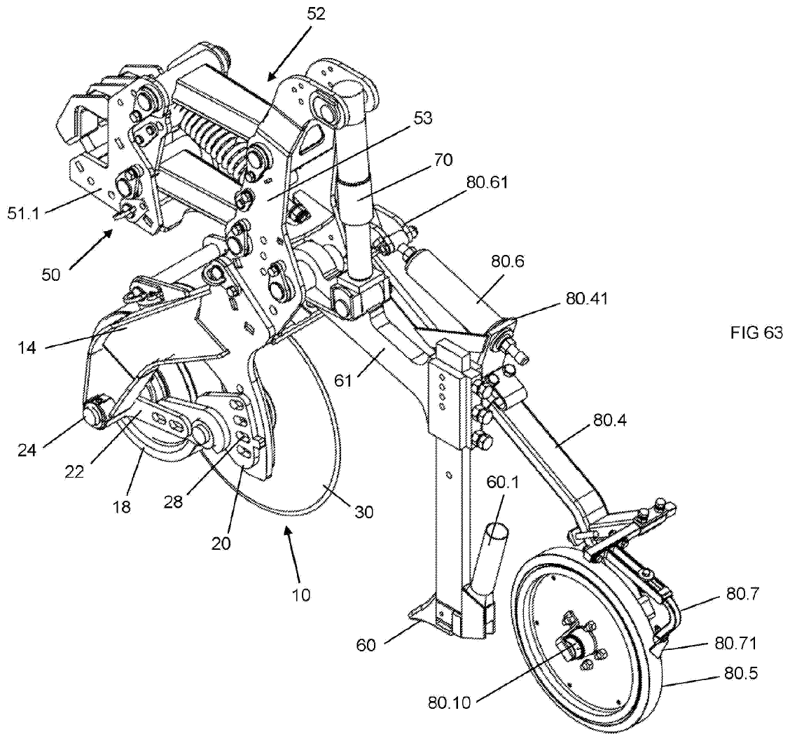

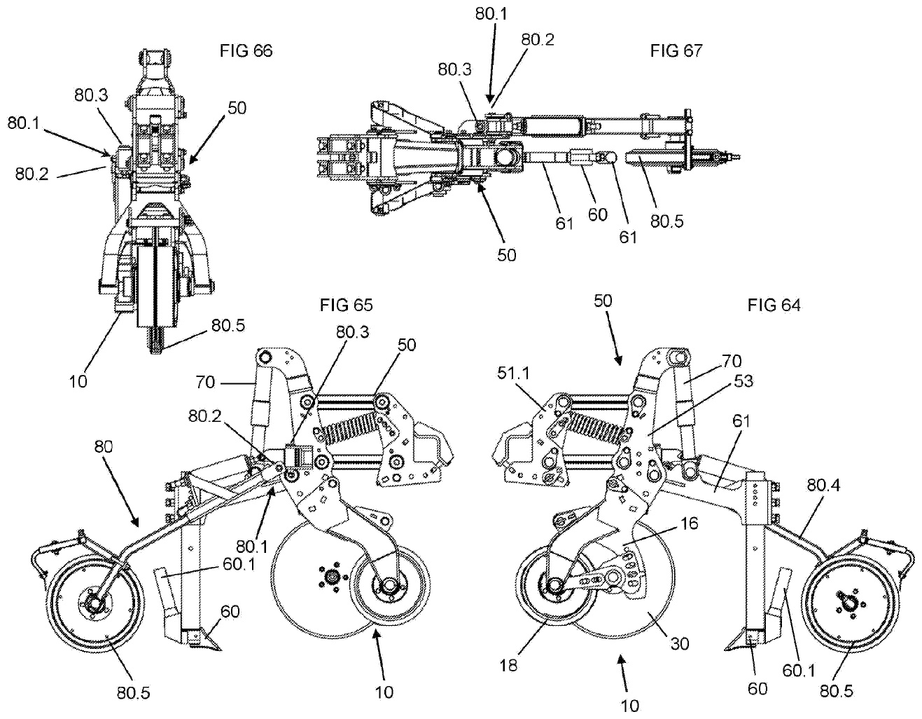

The support arms 52.1, 52.100 and 52.1000 also provide an advantage to the mounting arrangement of a press wheel such as depicted and described below with respect to FIGS. 63 to 66.

As best illustrated in FIGS. 6, 8, 10, 11, 63, and 68, the mounting system 50 has a bias means 81, which is located at an angle to the horizontal and is pinned for pivotal movement with respect to the bracket 51.1 at an upper location on bracket 51.1, and pinned for pivotal movement with respect to the bracket 53 at a lower location on bracket 53. The bias means 81 is a helical compression spring, which can be adjusted as is known in the art, so that a predetermined amount of ground engaging force can be applied to the bracket 53, thereby applying such generated force to the device 10 (and thus gauge wheel 18 and implement 30) via the frame assembly 12, and to the tyne 60 via bracket 61.

The implement mounting system 50 has a parallelogram linkage system 52 formed by upper and lower arms 52.1, and their respective pivot or mounting points 51.12 and 53.12 to the brackets 51.1 and 53 respectively. The parallelogram linkage system 52 maintains the ground engaging device 10 and the tyne 60 at the predetermined orientation to the ground, so that when in use, this will not change if changes in height and or depth happen to be encountered.

The support arm 52.1, being an upper linkage and a lower linkage of a parallelogram linkage system 52, provides to the implement mounting system 50, better lateral stability and rigidness than prior art constructions.

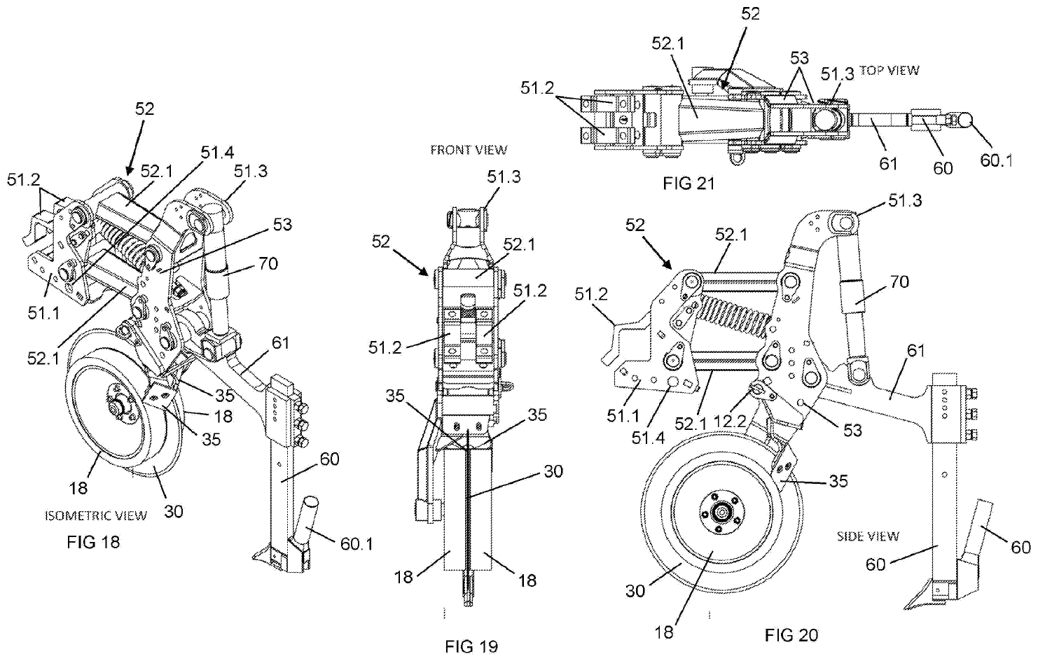

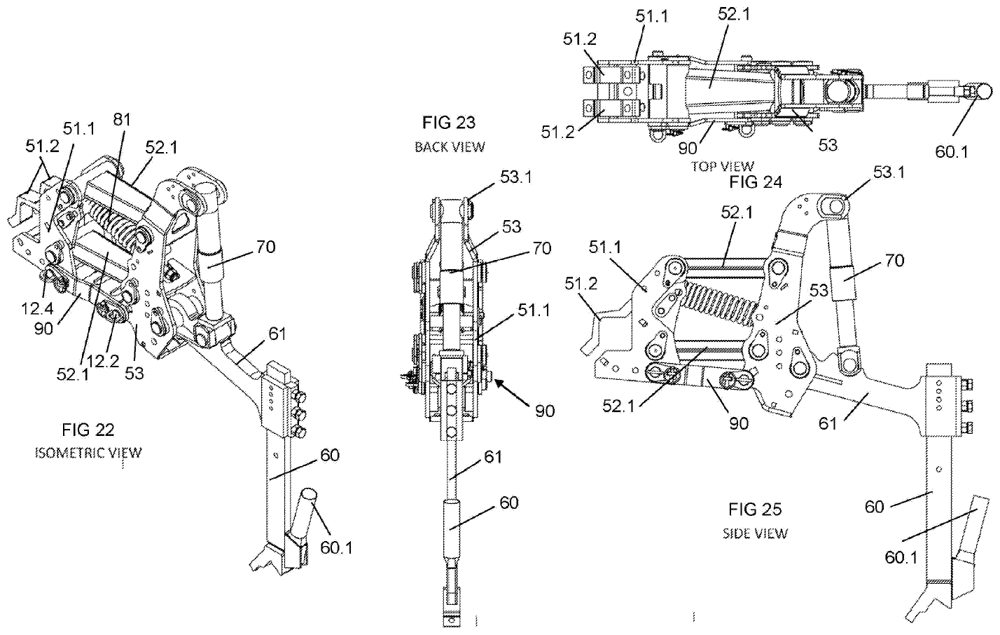

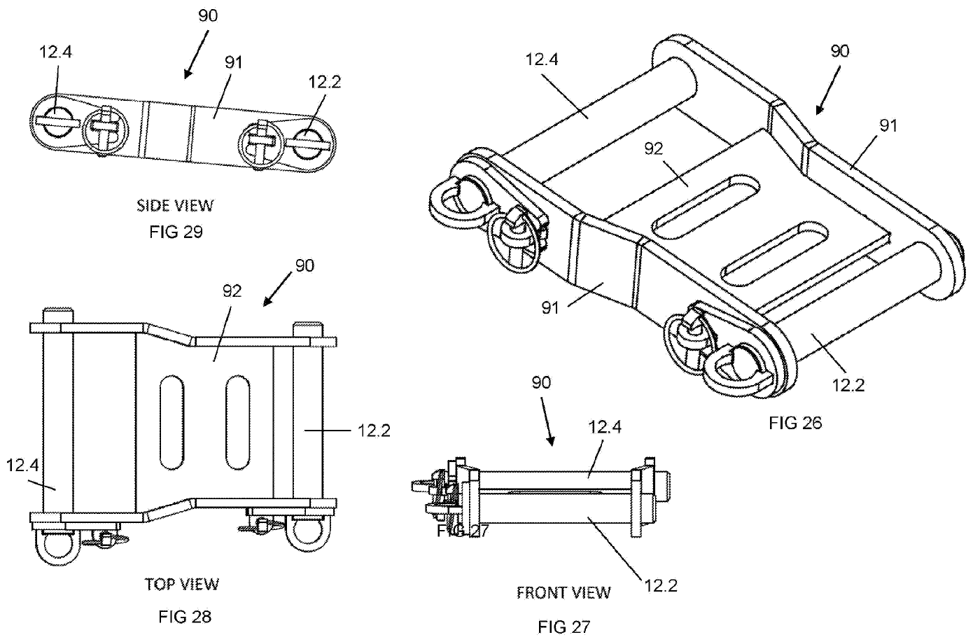

Illustrated in FIGS. 18 to 21 is the improved mounting system 50 of earlier Figures, with the ground engaging device 10 being replaced by a conventional trasher 10′. The conventional trasher 10′ has two gauge wheels 18, with a concentrically arranged cylindrical coulter 30, and two scrapers 35 each of which engages both a gauge wheel 18 and a respective side of the coulter 30, keeping them clear of soil debris which would otherwise interfere with the operation of the trasher. In respect of the ground engaging devices 10, 10.100, 10.110 and 10.120 described above and below, can have appropriately located scrapers which can also be positioned on the frame assembly 12, but are not illustrated. It can be seen in the trasher 10′ of FIGS. 18 to 21, that the trasher 10′ does not include a third connection point 12.4, and as such the parallelogram linkage system 52 of the mount 50 is free to function.

Whereas in FIGS. 22 to 25, is the improved implement mount 50, without any trasher connected, but includes a locking link 90, as best illustrated in FIGS. 26 to 29, which is connected to the same connection points that pins 12.4 and 12.2 are connected to as described previously, to thereby lock the parallelogram linkage 52 into a single positon or arrangement. As illustrated in FIGS. 26 to 29, the link 90 has two side brackets 91 which are welded to a shaped and apertured brace 92, which keeps the bracket 91 in a spaced relationship. The brackets 91, as best seen in FIG. 28, have a shape or plan view that means one end is of a width which is greater than the other end, in much the same way as support arm 52.1 is constructed, due to the difference in spacing on the brackets 51.1 and 53. The forward and rearward ends of each bracket 91 include apertures to receive pins 12.4 and 12.2, so that the link 90 can be attached at respective ends to the apertures in brackets 51.1 and 53. The pins 12.2 and 12.4 are locked into place relative to the brackets 91, on one side of link 90, by means of convention pin securing mechanisms which utilise lynch pins, as is illustrated.

Illustrated in FIGS. 63 to 67, is the implement mounting system 50, the ground engaging device 10, and rear located planter or cultivation tyne 60, as illustrated in FIGS. 6 to 9, and are assembled and constructed as described with reference to FIGS. 1 to 9. Implement mounting system 50 includes a press wheel assembly 80, which is connected to the right side of bracket 53, when viewed from the rear, by means of a two direction pivot 80.1, which allows for movement around a horizontal axis by pivot 80.2 as well as around a vertical axis by pivot 80.3. The vertical pivot 80.3 carries a yoke 80.61 which receives one end of a hydraulic cylinder 80.6. The press wheel arm 80.4 extends downwardly and rearwardly from the horizontal pivot 80.2 and has a horizontal stub axle 80.10 assembled to its rear end, onto which the press wheel 80.5 is assembled. The arm 80.4 includes a braced mounting bracket 80.41 about halfway along its length, so that the other end of the hydraulic cylinder 80.6 can be connected. Upon actuation of the hydraulic cylinder 80.6 to extend, the rear end of the arm 80.4 and press wheel 80.5 will rotate downwardly to apply pressure to the ground to compact the ground after seed has been planted.

The press wheel assembly 80 also includes a scraper arm 80.7 on the end of which is a scraper 80.71, so as to clean the press wheel 80.5 as it rotates.

The bracket 53 by being narrower than the bracket 51.1 allows the press wheel 80.5 to track and follow the tyne 60 so that the forces of the ground onto the wheel 80.5, have a lesser action to make the wheel otherwise attempt to track away from the centre line along which the tyne 60 is following.

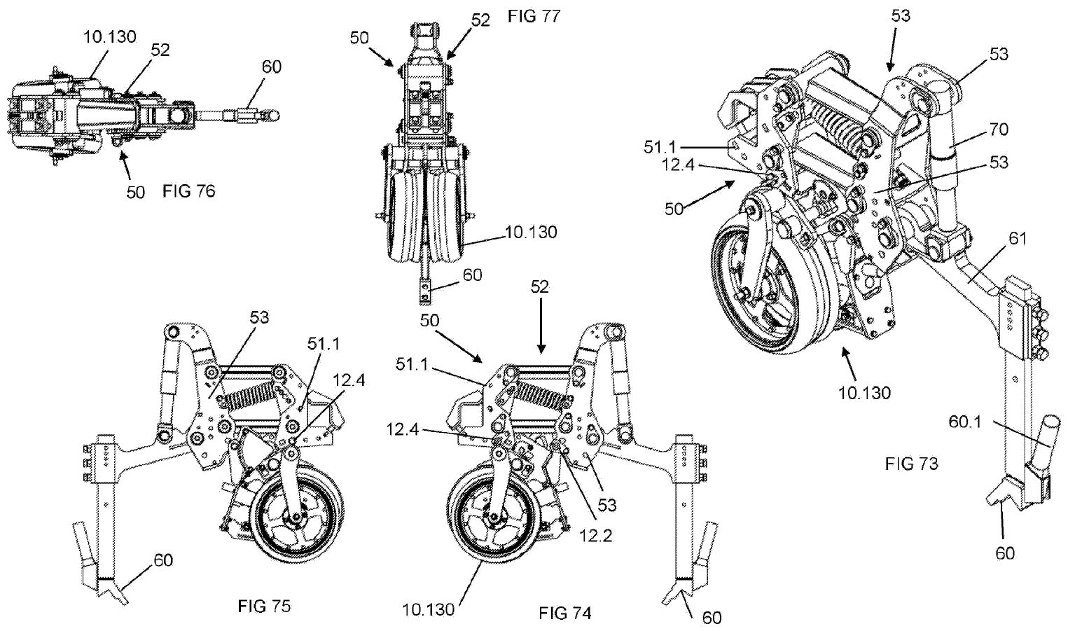

Illustrated in FIGS. 68 to 78 is a double disc planter 10.130, where in FIGS. 68 to 72, the double disc planter 10.130 is attached the implement mount 50 in a planting mode, while in FIGS. 73 to 77 the double disc planter 10.130 is attached to the implement 50 in a tillage mode where it's frame is used to lock up the parallelogram linkage 52, enabling the implement mount 50 and tyne 60 to perform a cultivation mode where the planter 10.130 is not in a ground engaging condition.

The double disc planter 10.130 is of a generally known construction, except where indicated below, and has a centrally located seed or fertilizer tube 10.131 which feeds directly to the open mouth of a shaped distributor 10.132, which is shaped to sit between the two coulters 30, which are angled with respect to each other. The distributor 10.132 has a clevis and pin arrangement 10.134 located at its upper forward end, so that the distributor 10.132 can be hingedly or pivotally mounted to the yoke 10.136 on the rear of the main bracket portion 10.135 of the frame assembly 12. Whereas the seed or fertilizer tube 10.131 is secured to the other main bracket horizontal portion 10.137 of the frame assembly 12, above aperture 10.133, so that when bracket portion 10.137 is mounted to bracket portion 10.135, by means of apertures 10.139 and 10.138 by the respective 4 bolt holes, seed or fertilizer tube 10.131 will feed into the mouth of the distributor 10.132. On the outside of the coulters 30 are the gauge wheels 18 which are mounted on depth controlled axles, as is known in the art with respect to double disc planter.

The double disc planter 10.130 differs from conventional double disc planters by the present of two brackets 10.140 which have rearwardly located upper and lower mounting holes 10.142, and a forward large diameter hole 10.143, the function of which will be described below. The mounting holes 10.142 at the forward end of generally vertically oriented bracket portion 10.129 of the frame assembly 12, allow the brackets 10.140 to be mounted by bolts (not illustrated) to the bracket portion 10.129, as is best illustrated in FIGS. 68 to 70 and 72. The large holes 10.143 in brackets 10.140, receive a pin like pin 12.4 of previous Figures, so as to lock up the parallelogram linkage 52, in the manner described previously, and as illustrated in FIGS. 73 to 77, by locking the brackets 10.140 to the bracket 51.1 via apertures 51.4, and thus the frame assembly 12 and its gauge wheels 18 and coulters 30 are locked away from their normal ground engaging condition.

The bracket or brackets 10.140 are a useful aftermarket addition to a standard double disc planter to allow it to operate to lock up the parallelogram linkage 52 allowing for deep tillage, without having to remove the double disc planter 10.130. In respect of an OEM double disc planter, the generally vertically oriented bracket portion 10.129 of the frame assembly 12 can have its shape changed, so as to extend forwardly so as to allow the positioning of a large hole similar to holes 10.143, to perform the linkage 52 lock up function in association with a pin like pin 12.4.

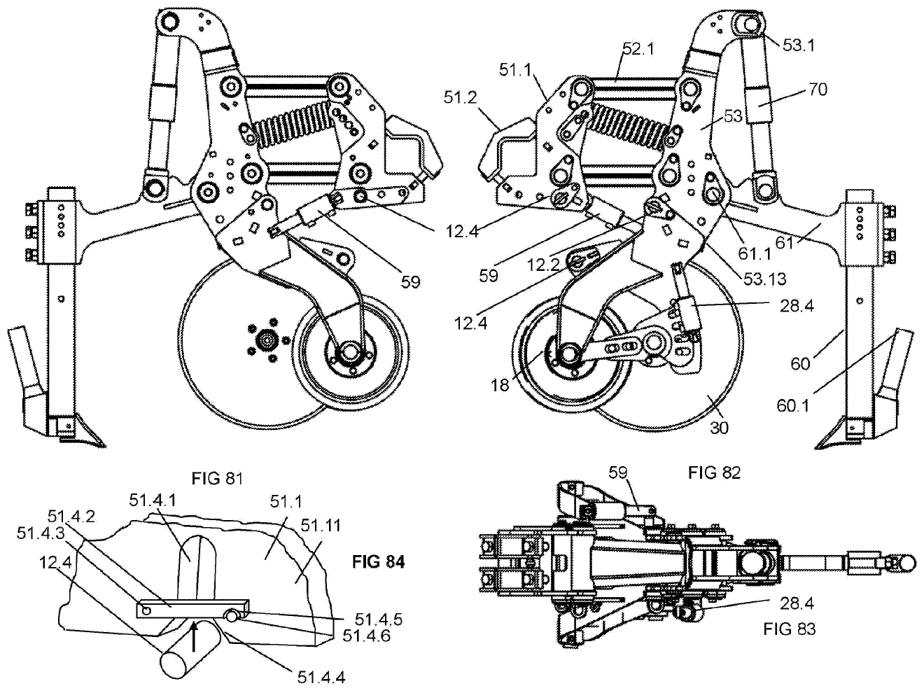

In the devices and parallelogram linkages described above, the frame assemblies 12, are used to lock up the parallelogram linkage 52, by a portion of the respective frame assembly 12 being pinned to holes 51.4 by pins 12.4, and another portion of the respective frame assembly 12 being pinned to the frame bracket 53 by pin 12.2. In another embodiment, as illustrated in FIG. 84, the hole 51.4 in bracket 51.1 is replaced by an open slot 51.4.1, into which pin 12.4 can travel into, when connected to the frame assembly 12 (or a similar welded pin formation), when the frame assembly 12 is rotated about pin 12.2, when mounting bolts in 12.3 are removed. The open slot 51.4.1 has opposed tapered lead-ins 51.4.4, and a cam-lock or gate 51.4.2 associated with it, which pivots around a bolt or axle 51.4.3. The other end of the cam-lock or gate 51.4.1 has a cylindrical cut out or portion 51.4.5, which will engage and rest on a stationary spigot or pin 51.4.6, which is welded to the bracket member 51.11. The cam-lock or gate 51.4.2, and spigot 51.4.6 can be located on the inboard side and or the outboard side of the bracket member 51.11 of parallelogram bracket 51.1. By this mechanism, the frame assembly 12 can be rotated about pin 12.2 and the pin 12.4 will move into the open slot 51.4.1, and it pushes past the cam-lock or gate 51.4.2 in the upward direction, with the cam-lock or gate 51.4.2 moving to a locked condition once clear of the pin 12.4, thereby locking the pin 12.4 in place on bracket 51.1, in the now closed open slot 51.4.1. This allows locking and securing to occur with a single action. Additionally, a repositionable hydraulic cylinder can be provided so as to selectively engage the frame assembly 12 and the linkage 52 or other part of the implement mounting system 50, so that the frame assembly 12 can be rotated from the ground engaged condition, to a locked-up condition where the linkage 52 no longer operates as a parallelogram. Alternatively, as illustrated in FIGS. 81 to 83, a permanently mounted hydraulic cylinder 59 can be provided which links each frame assembly 12 to the lower portion of bracket 51.1, whereby the frame assembly 12 can be moved to the locked condition from the ground engaging condition, and from the locked condition to the ground engaging condition, by the application of hydraulic pressure. Alternatively, the hydraulic cylinder 59 can be substituted by a pneumatic cylinder or linear actuator.

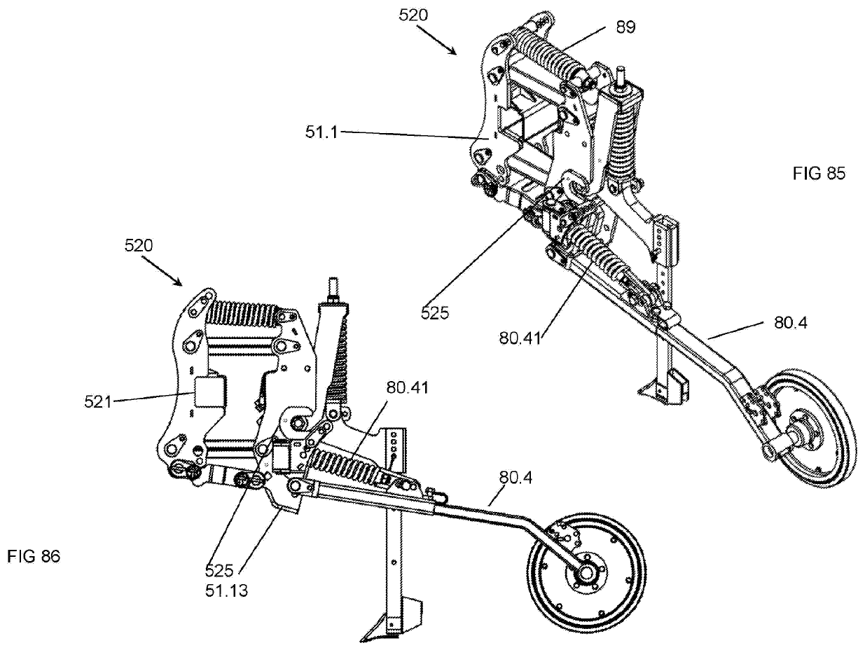

Illustrated in FIGS. 85 to 92 there is parallelogram linkage 520 for a ground engaging implement, the linkage 20 having a first end 51.1 for mounting to a bar or frame (see FIG. 90) for carrying and or towing one or more ground engaging implements, and a second end 53 to which can be mounted one or more ground engaging devices or tools, the first end 51.1 including within the linkage 520 a connection means 521 to connect the linkage 520 to the bar or frame.

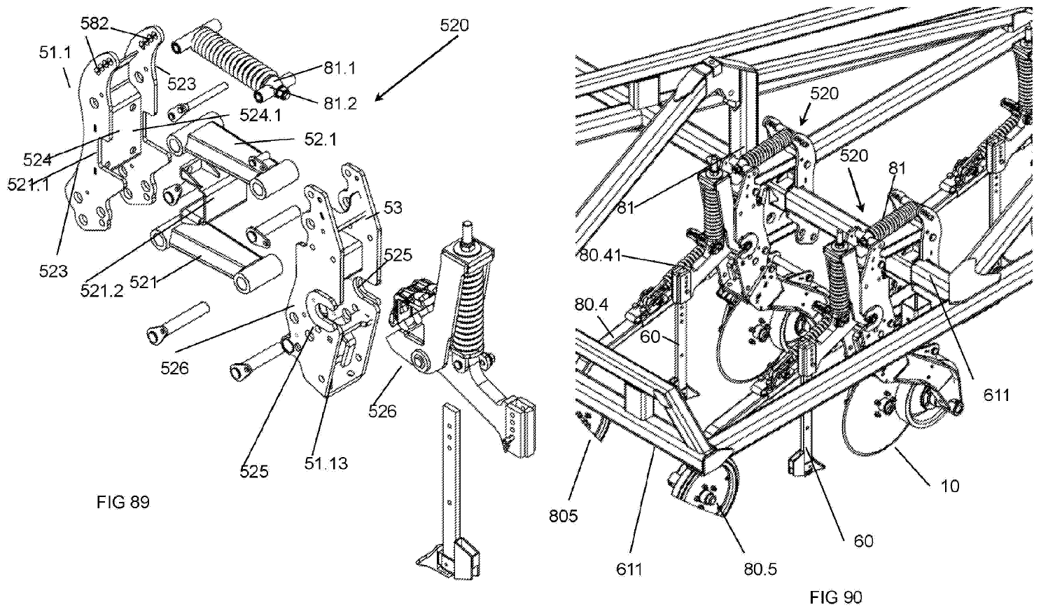

The first end 51.1 has a shaped cut-out 521.1 to receive a profile of the bar or frame. In the exploded view of FIG. 89, the cut-out 521.1 is shaped to receive three sides of a square or rectangular hollow section draw bar or main draw bar attached to a tractor or motive power unit. The bar or frame of the draw bar can be secured to the first end 51.1 by means of a bracket or brackets. In the illustration of FIG. 89, a single U-shaped bracket 521.2 is used which bolts to threaded holes in central spacer plate between the left and right side bracket plates or sides.

As illustrated in FIGS. 85 to 92, the first end 51.1 and the second end 53 have a compression spring 81 mounted between upper portions thereof. The compression spring 81 is located above an upper support arm of the linkage. The compression spring 81 can be adjustable by a collar 81.1 and nut 81.2, as best illustrated in FIG. 89. By winding up or loosening the nut 81.2 the spring force can be adjusted so as to provide the requisite force to balance the weight of the ground engaging implement mounted to the second end 53, and apply a required downward pressure on the ground engaging implement.

It will be noted that the first end 51.1 has three pairs of apertures 522 so as to selectively locate the forward pivot or pin holding the spring 81 to the first end 51.1.

The end 51.1 is constructed of two side bracket plates, which are welded to central spacer 524, which is a shaped plate, which has central portion 524.1, having four threaded holes to bolt the U-shaped bracket 521.2 to thereby secure the first end 51.1 to a draw bar.

The mounting of the draw bar within the linkage 520 has several advantages. The first is that it decreases the length between rows of draw bars on an implement, and this in turn allows the parallelogram linkage 520 to be retro-fitted to tillage machines, which allows them to become precision planters. Another advantage is that as the draw bar is pushing the end 51.1, the strength of the first end 51.1 is used to carry and transmit the ground engaging forces, between the ground engaging tool and the draw bar. Whereas with conventional linkages, these are carried and transmitted by means of U-bolts and or plates and bolts under tension, which end up not being as strong as the arrangement described above.

As is best illustrated in FIG. 89, the second end 53 has two rearwardly directed slots 525 in each bracket plate. These slots can be provided so as to accommodate assembly nuts and bolt heads 526 on the planter tyne mount. By virtue of the presence of the slots 525, a horseshoe shaped or U-shaped reinforcing plate 526 is welded to the outboard side of each bracket of the end 53, so that this region is suitably reinforced.

Another feature of parallelogram linkage 520, as illustrated in FIGS. 85 to 92, is that it has the bias means or compression spring 81 located outside the inner spaces of the linkage 520 and mounted between upwardly extending portions of the first end and second end and above the upper support arm.

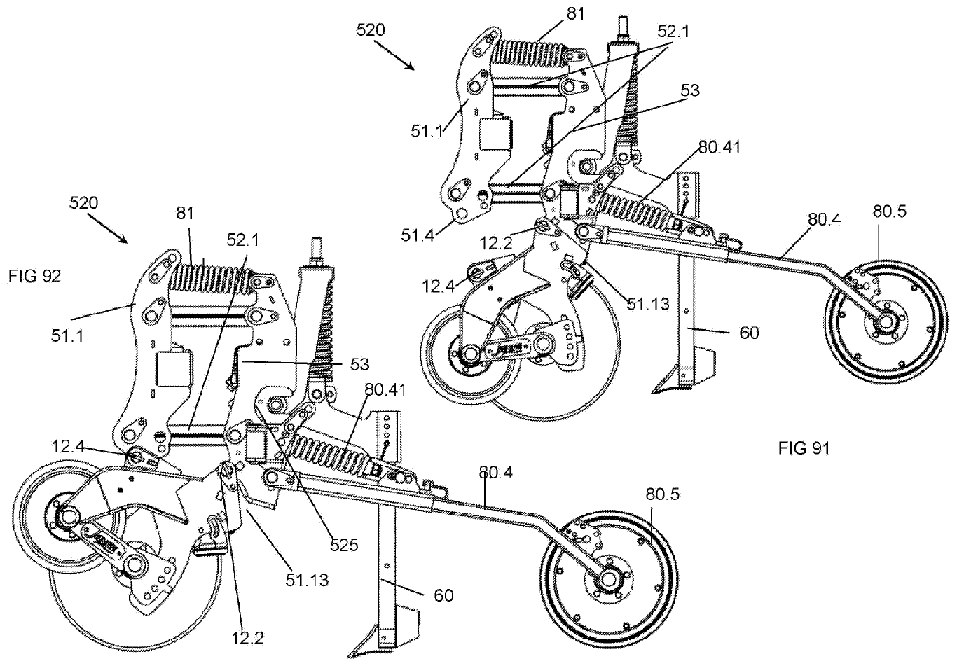

The linkage 520 is also similar to those described earlier in that it can be locked against movement by a bracket 90 as in FIGS. 85 and 86, or it can be locked by ground engaging device or tool 10, 10.100, 10.110, 10.120, 10.130 (see FIGS. 68 to 78) as in FIGS. 91 and 92, also as previously described. In FIGS. 91 and 92 the tool 10 is illustrated. In FIG. 91, it is mounted to the mounting formation 53.13 and is ground engaging. Whereas in FIG. 92, it has been released to be pivoted around pin 12.2, so that the pin 12.4 can be used to pin it to the aperture 51.4 on the base of the end or bracket 51.1. In the condition of FIG. 92, the tool 10 can be either ground engaging or not, depending upon the geometry utilised.

It will be noted in FIGS. 85 and 86 and 91 and 92, that the second end 53 has pivoted to a lower end, a press wheel mounting arm 80.4 and press wheel 80.5, and this applies pressure under gravity but is balanced or adjusted by means of a tension spring which interconnect the arm 80.4 to another location on the second end 53.

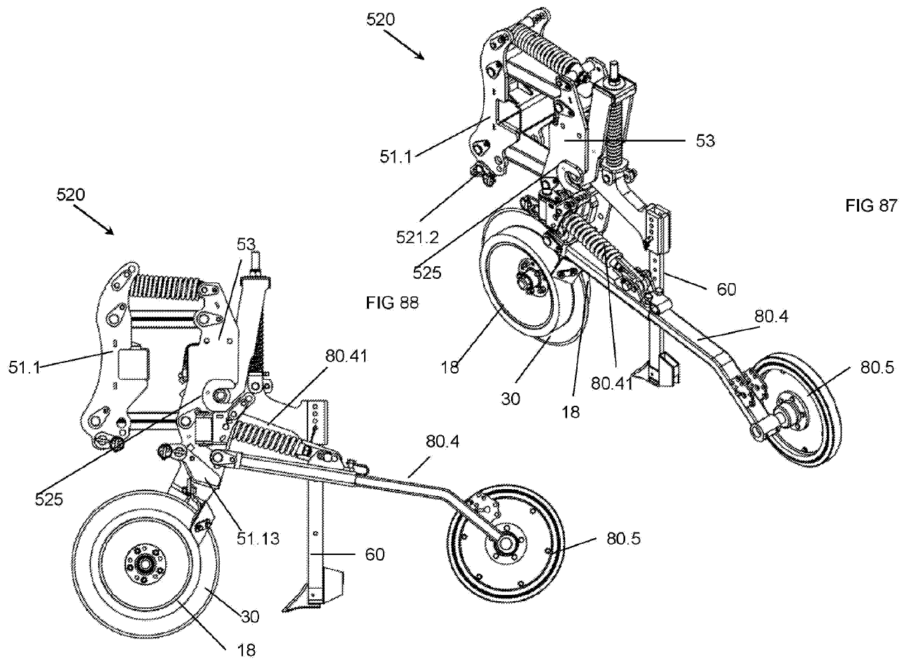

It will also be seen that in FIGS. 85 and 86, as the only implements mounted on linkage 520 are the press wheel 80.5 and the planting tyne 660, that the linkage 520 is locked by means of the bracket 90. Whereas in FIGS. 87 and 88, a combination of implement 30 and gauge wheels 18 are mounted to the implement mount 53.13, and it will be noted that the linkage 520 is not in a locked condition.

As is best illustrated in FIG. 90 the linkage 520 is shown mounting a ground engaging device or tool 10 to what is ostensibly a frame as used by a tillage machine, as such frames have their draw bars 611 at comparatively shorter spacing than a precision planter. This means that the linkage 520 allows the tillage machine frame to double as both a tillage machine and a precision planter.

In respect of the ground engaging devices described above, it will be readily understood that ancillary equipage such as mud scrapers and the like will also be fitted by means of any appropriate or known fitting method, so as to be able to scrape respective components including the coulters or implements 30.

The present invention also provides a planter, fertiliser, cultivator or trasher having at least one of, or a combination of two or more of the following: at least one ground engaging device as described herein; at least one implement mounting system as described herein; at least one support arm as described; at least one parallelogram linkage having a support arm as described herein; at least one parallelogram linkage as described herein.

Where ever it is used, the word “comprising” is to be understood in its “open” sense, that is, in the sense of “including”, and thus not limited to its “closed” sense, that is the sense of “consisting only of”. A corresponding meaning is to be attributed to the corresponding words “comprise”, “comprised” and “comprises” where they appear.

It will be understood that the invention disclosed and defined herein extends to all alternative combinations of two or more of the individual features mentioned or evident from the text. All of these different combinations constitute various alternative aspects of the invention.

While particular embodiments of this invention have been described, it will be evident to those skilled in the art that the present invention may be embodied in other specific forms without departing from the essential characteristics thereof. The present embodiments and examples are therefore to be considered in all respects as illustrative and not restrictive, and all modifications which would be obvious to those skilled in the art are therefore intended to be embraced therein.

1. A parallelogram linkage for a ground engaging implement, said linkage having a first end for mounting to a frame for carrying and or towing one or more ground engaging implements, and a second end to which can be mounted one or more ground engaging devices or tools, said first end including spaced first bracket members to receive two first pivot pins between them, and said second end including spaced second bracket members to receive two second pivot pins between them, said linkage also including a first support arm and a second support arm which pivotally connects said first end to said second end, and wherein spacing between said first bracket members is greater than spacing between said second bracket members.

2. A parallelogram linkage as claimed in claim 1, wherein said first end and said second end each include pivot or bolt receiving apertures, which permit either a bracket or said ground engaging device or tools, to be pinned thereto in order to lock said parallelogram linkage.

3. A parallelogram linkage as claimed in claim 1, wherein said second end includes a mounting formation for receiving a ground engaging tool, said mounting formation permitting said ground engaging tool to be rotatably secured to said second end by means of a pivot.

4. A parallelogram linkage as claimed in claim 3, wherein mounting formation also includes means to bolt or otherwise secure said ground engaging tool.

5. A parallelogram linkage as claimed in claim 1, wherein said ground engaging device or tool, when connected to said first end and said second end thereby locking said linkage, is retracted and is not in a ground engaging arrangement.

6. A parallelogram linkage as claimed in claim 1, wherein said ground engaging device or tool, when connected to said first end and said second end thereby locking said linkage, is operative, at least in part, so as to be in a ground engaging arrangement.

7. A parallelogram linkage as claimed in claim 1, wherein said a first and second support arm include bushings at either end, said bushings being received between said spaced first bracket members and said spaced second bracket members.

8. A parallelogram linkage as claimed in claim 1, wherein at least one of said support arms includes a taper or converging portion in the direction of said first end to said second end.

9. A parallelogram linkage as claimed in claim 8, wherein said taper or converging portion is present in the width and or height of the at least one support arm.

10. A parallelogram linkage as claimed in claim 1, wherein said support arm includes an upper portion and a lower portion and a first and a second side, wherein said first and second sides each include converging formations whereby the width of said support arm at a central portion of said first and second sides is different to a width of said support arm away from said central portion of said first and second sides.

11.-18. (canceled)

19. An implement mounting system having at least one parallelogram linkage as claimed in claim 1.

20. An implement mounting system as claimed in claim 19, wherein said mounting system includes a bias means.

21-51. (canceled)

52. A parallelogram linkage as claimed in any claim 1, or an implement mounting system having such a parallelogram linkage, wherein said parallelogram linkage is adapted to be locked to prevent the parallel operation of said linkage.

53. A parallelogram linkage or implement mounting system as claimed in claim 52, wherein said linkage includes means to pivotally receive a portion of a ground engaging device at one end of said linkage, and means at another end of said linkage to receive another portion of said ground engaging device, to thereby lock said linkage from operating.

54. A parallelogram linkage or implement mounting system as claimed in claim 52, wherein said ground engaging device is moveable to a parallelogram linkage locked condition by means of a motive power means such as a hydraulic, pneumatic or linear actuator.

55. A parallelogram linkage for a ground engaging implement, said linkage having a first end for mounting to a bar or frame for carrying and or towing one or more ground engaging implements, and a second end to which can be mounted one or more ground engaging devices or tools, said first end including within said linkage a connection means to connect said linkage to said bar or frame.

56.-64. (canceled)

65. A parallelogram linkage as claimed in claim 55, wherein said first end and said second end each include pivot or bolt receiving apertures, which permit either a bracket or said ground engaging device or tools, to be pinned thereto in order to lock said parallelogram linkage.

66. A parallelogram linkage as claimed in claim 65, wherein said ground engaging device or tool, when connected to said first end and said second end thereby locking said linkage, is retracted and is not in a ground engaging arrangement.

67. A parallelogram linkage as claimed in claim 65, wherein said ground engaging device or tool, when connected to said first end and said second end thereby locking said linkage, is operative, at least in part, so as to be in a ground engaging arrangement.

68. A planter, fertiliser, cultivator or trasher having at least one implement mounting system as claimed in claim 19.
